(19) United States
(12) Patent Application Publication
(10) Pub. No.: US 2025/0016407 A1
(43) Pub. Date: Jan. 9, 2025

(54) MEASURING VIDEO-PROGRAM VIEWING

(71) Applicant: Comcast Cable Communications, LLC, Philadelphia, PA (US)

(72) Inventor: Robert Alan Orlowski, Centennial, CO (US)

(21) Appl. No.: 18/894,740

(22) Filed: Sep. 24, 2024

Related U.S. Application Data
(63) Continuation of application No. 14/020,778, filed on Sep. 6, 2013.

(51) Int. Cl. H04N 21/442; H04N 21/24; H04N 21/25; H04N 21/258; H04N 21/466; H04N 21/658; H04N 21/845

(52) U.S. Cl. CPC H04N 21/442; H04N 21/2408; H04N 21/252; H04N 21/25883; H04N 21/44226; H04N 21/4667; H04N 21/6582; H04N 21/8456

(57) ABSTRACT

A computer-implemented method of using video program viewing activity data as input to calculate video viewing activity for Linear, DVR, and VOD program level viewing, including measuring trick play activity. Program viewing data may be aggregated based on a variety of categories and used to determine viewing activity metrics. The viewing activity metrics provide detailed data for calculating information on customer viewing behavior.

### CROSS-REFERENCE TO RELATED APPLICATIONS

This application is a continuation of and claims priority to U.S. patent application Ser. No. 14/020,778, filed Sep. 6, 2013, which is hereby incorporated by reference in its entirety.

This application is also a related to U.S. Pat. No. 8,365,212 B1 issued on Jan. 29, 2013 entitled “SYSTEM AND METHOD FOR ANALYZING HUMAN INTERACTION WITH ELECTRONIC DEVICES THAT ACCESS A COMPUTER SYSTEM THROUGH A NETWORK” by the present inventor which is incorporated by reference in its entirety but is not admitted to be prior art.

This application is also related to U.S. Pat. No. 8,365,213 B1 issued on Jan. 29, 2013 entitled “SYSTEM AND METHOD FOR MEASURING TELEVISION ADVERTISING AND PROGRAM VIEWING AT A SECOND-BY-SECOND LEVEL AND FOR MEASURING EFFECTIVENESS OF TARGETED ADVERTISING” by the present inventor which is incorporated by reference in its entirety but is not admitted to be prior art.

This application is also related to the co-pending application U.S. application Ser. No. 13/360,704 filed on Jan. 28, 2012 entitled “SYSTEM AND METHOD FOR MEASURING LONGITUDINAL VIDEO ASSET VIEWING AT A SECOND-BY-SECOND LEVEL TO UNDERSTAND BEHAVIOR OF VIEWERS AS THEY INTERACT WITH VIDEO ASSET VIEWING DEVICES THAT ACCESS A COMPUTER SYSTEM THROUGH A NETWORK” by the present inventor which is incorporated by reference in its entirety but is not admitted to be prior art.

This application is also related to the co-pending application U.S. application Ser. No. 13/567,073 filed on Aug. 5, 2012 entitled “SYSTEM AND METHOD FOR MEASURING LINEAR, DVR, AND VOD VIDEO PROGRAM VIEWING AT A SECOND-BY-SECOND LEVEL TO UNDERSTAND BEHAVIOR OF VIEWERS AS THEY INTERACT WITH VIDEO ASSET VIEWING DEVICES DELIVERING CONTENT THROUGH A NETWORK” by the present inventor which is incorporated by reference in its entirety but is not admitted to be prior art.

This application is also related to the co-pending application U.S. application Ser. No. 13/740,199 filed on Jan. 13, 2013 entitled “SYSTEM AND METHOD FOR MEASURING DEMOGRAPHIC-BASED HOUSEHOLD ADVERTISING REACH; IMPRESSIONS, SHARE, HUT, RATING, AND CUMULATIVE AUDIENCE; AND VIDEO PROGRAM VIEWING, BASED ON SECOND-BY-SECOND HOUSE LEVEL VIEWING ACTIVITY, TO UNDERSTAND BEHAVIOR OF VIEWERS AS THEY INTERACT WITH VIDEO ASSET VIEWING DEVICES DELIVERING CONTENT THROUGH A NETWORK” by the present inventor which is incorporated by reference in its entirety but is not admitted to be prior art.

This application is also related to the co-pending application U.S. application Ser. No. 14/013,031 filed on Aug. 29, 2013 entitled “SYSTEM AND METHOD FOR USING THE HADOOP MAPREDUCE FRAMEWORK TO MEASURE VIDEO CONTENT VIEWING ON SECOND-BY-SECOND LEVEL TO UNDERSTAND BEHAVIOR OF VIEWERS AS THEY INTERACT WITH VIDEO ASSET VIEWING DEVICES DELIVERING CONTENT THROUGH A NETWORK” by the present inventor which is incorporated by reference in its entirety but is not admitted to be prior art.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND—PRIOR ART

I have not found any relevant prior art at the present time.

### BACKGROUND INFORMATION

### General Statement of Problem

With the ever increasing number of consumer choices for television viewing, it is important for advertisers, content producers, and service providers such as cable television and satellite television and internet protocol television companies to be able to accurately measure audience viewership. I have discussed this problem extensively in my prior applications. This application teaches how to analyze video viewing activity related to sessionized or program-based linear viewing, digital video recording playback viewing, and video on demand viewing using the Hadoop MapReduce distributed computing framework. The reader will readily recognize that video on demand encompasses a wide range of video content including, but not limited to, cable and/or satellite television video on demand, all variety of video content delivered electronically across a network, and online educational videos.

### Existing Tools for Data Analysis

In my prior application U.S. application Ser. No. 13/567,073 filed on Aug. 5, 2012 I taught how to analyze sessionized or program-based linear viewing, digital video recording playback viewing, and video on demand viewing by loading the viewing activity data into arrays in the memory of a computer and then running algorithms against that data. In certain cases, an analyst may wish to use the Hadoop MapReduce distributed computing framework to analyze sessionized or program-based linear viewing, digital video recording playback viewing, and video on demand viewing. I have not identified any patents that teach how to use MapReduce to solve this problem.

### SUMMARY

In accordance with one embodiment, I disclose a computer-implemented method of aggregating sessionized or program-based linear viewing, digital video recording playback viewing, and video on demand viewing using the Hadoop MapReduce distributed computing framework. This will allow an analyst to aggregate second-by-second video viewing activity for this kind of viewing. Once this data has been aggregated, it can be used in any number of downstream analytic processes to provide detailed information on customer viewing behavior which can be used to drive business decisions for service providers, advertisers, and content producers.

### Advantages

By using the Hadoop MapReduce distributed computing framework to aggregate sessionized or program-based linear viewing, digital video recording playback viewing, and video on demand viewing, an analyst can harness the power of hundreds or even thousands of processors working in parallel to solve the problem of aggregating this video viewing activity data. This will allow an analyst to work with data sets of all sizes including extremely large data sets. The resulting files can be loaded to a relational database for various analytics similar to what I have taught in my other patent applications referenced previously. Additionally, the resulting files can be used in other Hadoop processes to correlate video viewing activity with other social media activity, with weather, with other programming content, and similar uses.

### Definitions

The following are definitions that will aid in understanding one or more of the embodiments presented herein:

Aggregated Video viewing activity means any measurements or aggregations produced by the MapReduce distributed computing framework as it aggregates video program viewing detail records or any value calculated by a Data Analysis Program as part of this process.

Computer readable format means any data format that can be read by a computer program or a human being as necessary. Nonlimiting examples include:
(i) formatted text files,
(ii) pipe delimited text files,
(iii) data base tables,
(iv) Extensible Markup Language (XML) messages,
(v) a printed report,
(vi) JavaScript Object Notation messages.

Data analysis computer system means a combination of one or more computers on which a Data Analysis Program or Programs or Hadoop or MapReduce processes can be executed. Nonlimiting examples include:
(i) one or more computers where video program viewing activity data can be used to create video program viewing detail records,
(ii) a single computer running the MapReduce distributed computing framework for parallel processing,
(iii) a cluster of many computers running the MapReduce distributed computing framework for parallel processing where many means a few to hundreds or even thousands,
(iv) a Hadoop cluster of computers.

Data analysis computer of known type means any commonly available computer system running a commonly known operating system. Nonlimiting examples include:
(i) a standard personal computer running WINDOWS 7 Professional operating system from MICROSOFT.R™. Corporation,
(ii) a computer running the UNIX operating system,
(iii) a computer running the Linux operating system,
(iv) a computer in a cloud computing environment,
(v) a mainframe computer with its operating system.

Data analysis program means a computer program or programs that are able to execute on a Data analysis computer of known type. Nonlimiting examples include:
(i) a Pig Latin script running MapReduce,
(ii) a JAVA program running MapReduce,
(iii) a Python script running MapReduce,
(iv) a COBOL program.

Demographic information means any data item that can describe a characteristic of a viewer or a subscriber or a household associated with a viewer who is operating the video asset viewing device. Nonlimiting examples include income, ethnicity, gender, age, marital status, location, geographic area, postal code, census data, occupation, social grouping, family status, any proprietary demographic grouping, segmentation, credit score, dwelling type, homeownership status, property ownership status, rental status, vehicle ownership, tax rolls, credit card usage, religious affiliation, sports interest, political party affiliation, cable television subscriber type, cable television subscriber package level, and cell phone service level.

Device Characteristic means any feature or capability or aspect or descriptive qualifier or identifier of a video viewing device. Nonlimiting examples include that this may identify the type of device such as a set-top box, a tablet, a smart phone; a capability of the device such as the ability to record video or to support multiple viewing windows, or a manufacturer identifier.

Device Type is a subset of Device Characteristic where device type may, as a nonlimiting example, identify the type of device such as a set-top box, a tablet, a smart phone.

Digital Video Recorder means a device that records video content from a network for later playback. This includes but is not limited to set-top box DVR, network DVR, and cloud DVR.

DVR—see Digital Video Recorder.

Digital Video Recording (DVR) Playback is when the viewer plays back content that was previously recorded on their DVR. DVR content can be viewed using various Trick Play features.

Geographic information means any service area or any network hierarchy designation or marketing area or other designated area used by a cable television company or a satellite television company or IP Television delivery company or educational service provider or video asset delivery system. The boundary or description of a geographic area is defined based on the needs of the service provider. Nonlimiting examples include a Market in a cable company network, a Headend in a cable company network, a Hub in a cable company network, a census tract, a cell tower identifier, a service area for satellite TV, advertising zone, a zip code, or some other geographic identifier. The geographic information may then be used to identify the location of a video asset viewing device or geographic information about the about the house associated with the device or the location of the device at the time of the viewer interaction in the event that the viewer interaction occurs in a location different than the location of the house associated with the device.

Network means any computer network. Nonlimiting examples include:
(i) a cable television network,
(ii) a cellular telephony network,
(iii) hybrid fiber coax system,
(iv) a satellite television network,
(v) a wi-fi network,
(vi) any means that supports communication among video asset viewing devices or electronic devices or computers or computer systems.

Pipe delimited text files means data files where the fields are separated by the “I” character.

Sessionized Linear Viewing is linear tuning activity which has been transformed into program based viewing. A simple linear tuning event may cross program boundaries. That simple linear tuning event can be split into multiple program based linear viewing activity records by creating separate tuning records for each program that is viewed during the linear tuning event. The viewer may use “trick plays” when viewing this content. Additionally, the sessionized linear viewing may represent live viewing activity or time shifted viewing activity.

Set-top box means a video asset viewing device that receives external signals and decodes those signals into content that can be viewed on a television screen or similar display device.

The signals may come from a cable television system, a satellite television system, a network, or any other suitable means. A set-top box may have one or more tuners. The set-top box allows the user to interact with it to control what is displayed on the television screen. The set-top box is able to capture the commands given by the user and then transmit those commands to another computer system. For purposes of this application, stating that a set-top box tunes to a channel is equivalent to stating that a tuner in a set-top box has tuned to a channel. A set-top box may also play back previously recorded video content.

STB means Set-top box.

Trick Play means using features of the video viewing device to execute operations such as Play, Fast Forward at various speeds (1.times., 2.times., 3.times., 4.times.), Pause, Skip, Reverse at various speeds (1.times., 2.times., 3.times., 4.times.), Slow play, slow reverse, and similar activities.

Tuner means a tuner in a Set-top box.

Tuner index means an identifier of a tuner in a Set-top box.

Video On Demand (VOD) a video service whereby previously recorded video content is made available for viewing. VOD content can be viewed using various Trick Play features. The content may include, but is not limited to, cable and/or satellite television video on demand, all variety of video content delivered electronically across a network, and online educational videos.

Video asset means any programming content that may be viewed and/or heard. A Video Program may contain multiple Video Assets. Nonlimiting examples of Video Asset include:
(i) advertisements or commercials,
(ii) movies,
(iii) sports programs,
(iv) news casts,
(v) music,
(vi) television programs,
(vii) video recordings.

Video asset viewing device means any electronic device that may be used either directly or indirectly by a human being to interact with video content where the video content is provided by a cable television system or a satellite television system or a computer system accessed through a network. Nonlimiting examples include: Gaming station, web browser, MP3 Player, Internet Protocol phone, Internet Protocol television, mobile device, mobile smart phone, set-top box, satellite television receiver, set-top box in a cable television network, set-top box in a satellite television system, cell phone, personal communication device, personal video recorder, personal video player, two-way interactive service platforms, personal computer, tablet device.

Video server delivering video content through a network means any computer system, any individual piece of computer equipment or electronic gear, or any combination of computer equipment or electronic gear which enables or facilitates the viewer interaction with the video asset viewing device. Nonlimiting examples include:
(i) cable television system,
(ii) cable television switched digital video system,
(iii) cellular phone network,
(iv) satellite television system,
(v) web server,
(vi) any individual piece of computer equipment or electronic gear,
(vii) any combination of computer equipment or electronic gear.

Video viewing activity means any identifiable activity that a Video asset viewing device operator may do in regard to a Video asset viewing device and where such activity can be captured by the video asset viewing device or by the video server delivering video content through a network that supports the device. Nonlimiting examples include:
(i) power on/power off, open web page, close web page,
(ii) channel up/channel down/channel selection, play video content on web browser,
(iii) volume up/volume down/mute/unmute,
(iv) any trick play such as fast forward, rewind, pause
(v) recording video content,
(vi) playing back recorded video content,
(vii) invoking a menu, choosing a menu option,
(viii) any response to a screen prompt
(ix) playing live video content.

Viewer means the human being causing a Viewer interaction; the user of a Set-top box or a Video asset viewing device.

### BRIEF DESCRIPTION OF THE DRAWINGS

FIG. 1 provides an overview of an exemplary process for collecting viewer interaction data derived from a plurality of viewers interacting with video content that was delivered on a plurality of video asset viewing devices delivering content through a network and then loading that data to a Media Measurement Data Base.

FIG. 2 illustrates an exemplary media measurement process from creation of the video program viewing activity data file to creation of the various aggregated viewing activity files which can then be used in downstream analytic processes.

FIGS. 3A-3B illustrate example record layouts for a Video Program Viewing Activity Data File 130 record and corresponding data structure.

FIGS. 3C-3H illustrate example sample data associated with record layouts for a Video Program Viewing Activity Data File 130 record.

FIGS. 4A-4B illustrate example record layouts for a Video Program Viewing Detail Data File 150 record and corresponding data structure.

FIGS. 4C-4G illustrate example sample data associated with record layouts for a Video Program Viewing Detail Data File 150 record.

FIGS. 5A-5B illustrates example record layouts for an Aggregated Sessionized Linear Viewing Activity (LVA) File 220 record and corresponding data structure.

FIGS. 5C-5O illustrate example sample data associated with record layouts for an Aggregated Sessionized Linear Viewing Activity (LVA) File 220 record.

FIGS. 6A-6B Illustrate example record layouts for an Aggregated DVR Viewing Activity (DVR) File 230 record and corresponding data structure.

FIGS. 6C-6E illustrate example sample data associated with record layouts for an Aggregated DVR Viewing Activity (DVR) File 230 record.

FIGS. 7A-7B Illustrate example record layouts for an Aggregated VOD Viewing Activity (VOD) File 240 record and corresponding data structure.

FIG. 7C illustrates example sample data associated with record layouts for an Aggregated VOD Viewing Activity (VOD) File 240 record.

FIGS. 8A-8B Illustrate example record layouts for an Aggregated Video Program Viewing File 250 record and corresponding data structure.

FIG. 8C illustrates example sample data associated with record layouts for an Aggregated Video Program Viewing File 250 record.

### DETAILED DESCRIPTION OF THE DRAWINGS

When reading the information below, it can be appreciated that these are merely samples of table layouts, format and content, and many aspects of these tables may be varied or expanded within the scope of the embodiment. The table layouts, field formats and content, algorithms, and other aspects are what I presently contemplate for this embodiment, but other table layouts, field formats and content, algorithms, etc. can be used. The algorithms are samples and various aspects of the algorithms may be varied or expanded within the scope of the embodiment.

In one embodiment the MapReduce Aggregation Engine 200 can be implemented on computer clusters running a standard Hadoop distribution from Apache under the Linux operating system. The MapReduce Aggregation Engine 200 can be implemented in JAVA or Pig. The reader may find more information about various Apache open source projects from The Apache Software Foundation at http://apache.org. Pig is a dataflow scripting language used to run data flows on Hadoop. Pig uses the Hadoop Distributed File System and the Hadoop processing system which is MapReduce. Pig is an Apache open source project. The reader may find more information about Pig at http://pig.apache.org. Those skilled in the art will readily recognize these tools.

### Note on Media Measurement Data Model

Cable Television Laboratories, Inc. has published an “Audience Data Measurement Specification” as “OpenCable.™. Specifications, Audience Measurement, Audience Measurement Data Specification” having Document Control Number “OC-SP-AMD-101-130502” copyright.COPYRGT. Cable Television Laboratories, Inc. 2013 which describes a Media Measurement Data Model (MMDM) database design which can be used as a source of data for the MapReduce Aggregation Engine 200 which I teach how to build in this Application. The teaching in my present application can be implemented in conjunction with that Media Measurement Data Model or with any number of data models as long as the required input data is provided as described herein.

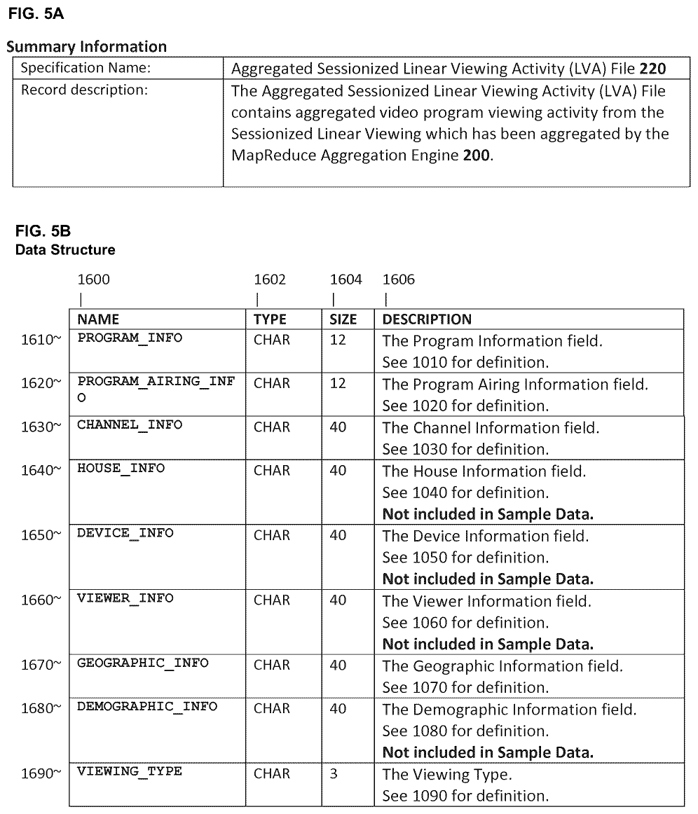

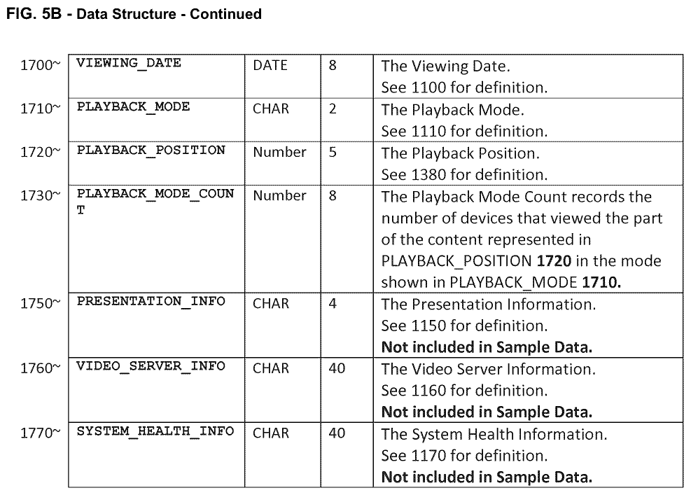

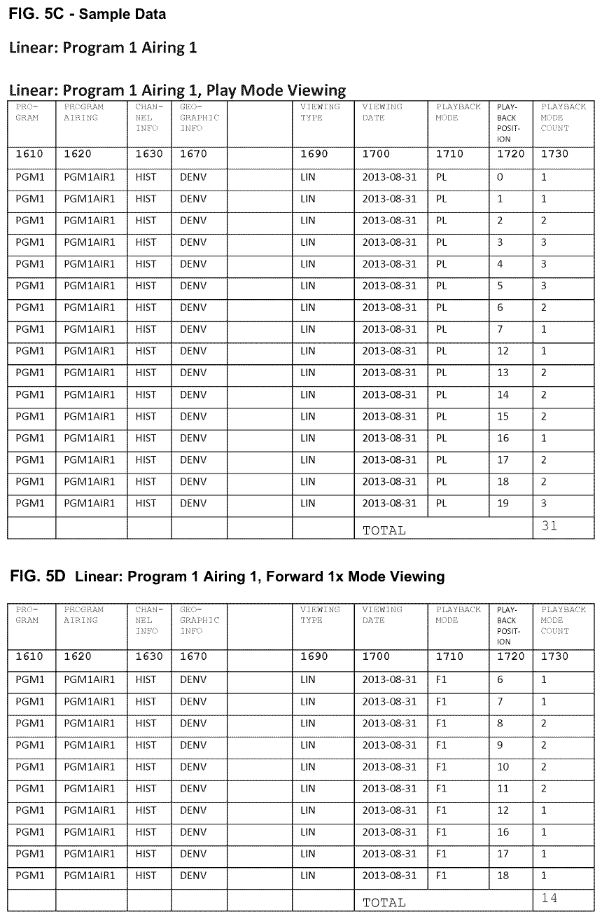

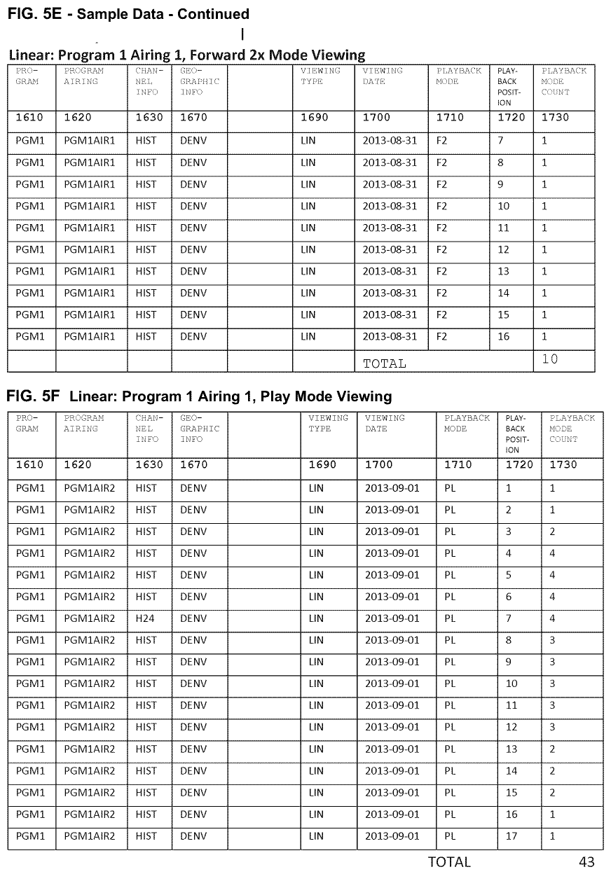

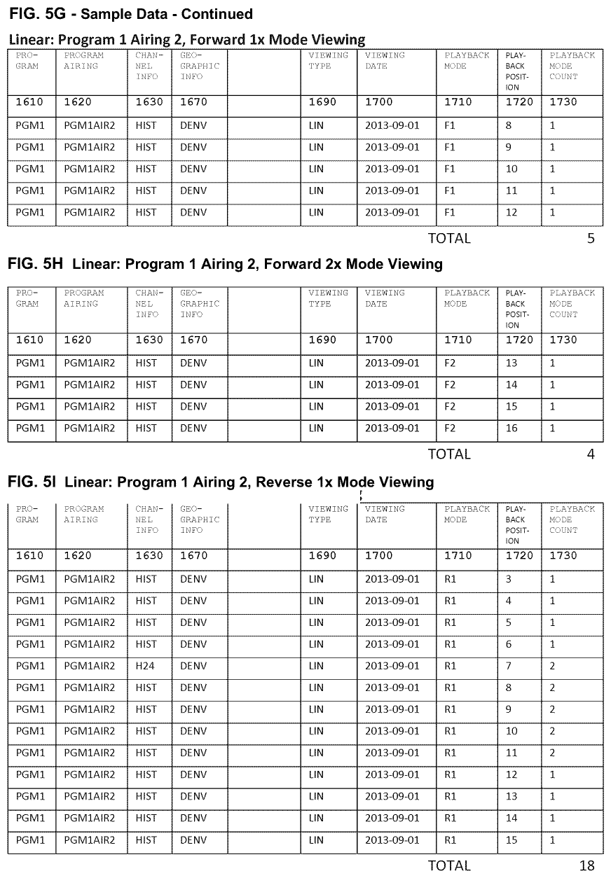

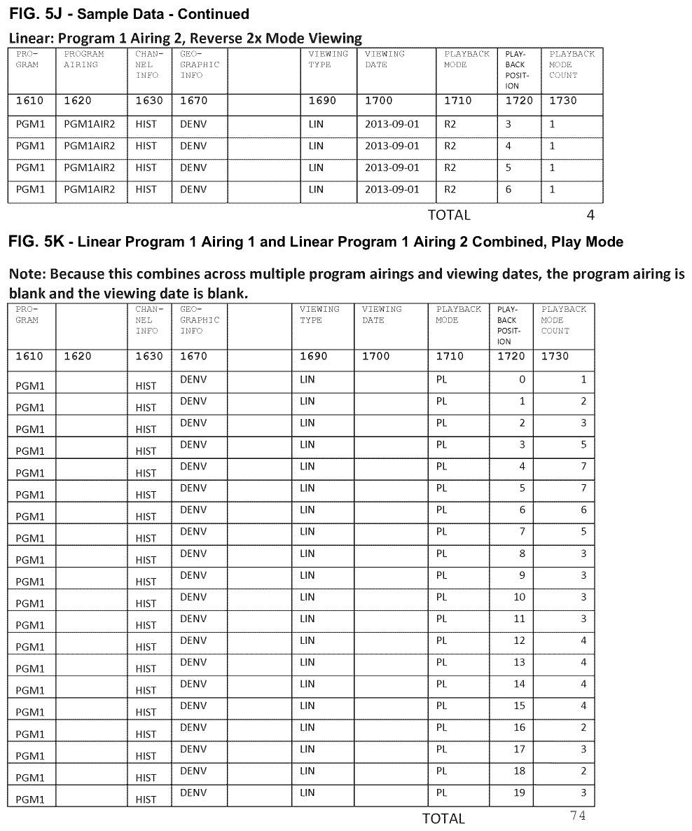

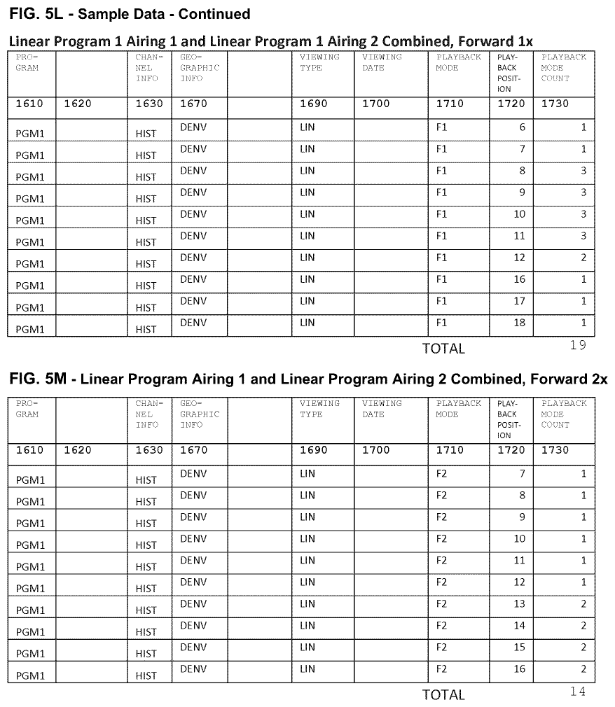

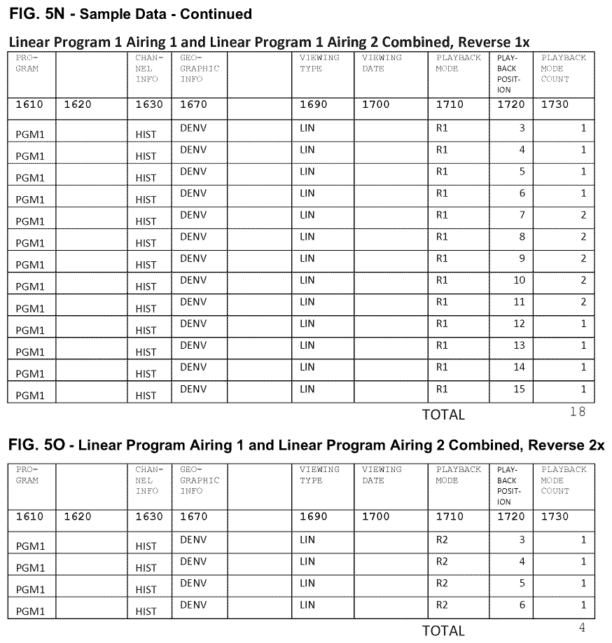

Additionally, my MapReduce Aggregation Engine 200 creates files which may be used to load additional tables in a Media Measurement Data Model such as the one published by Cable Television Laboratories, Inc. These files are described in FIGS. 5 to 8.

Note: Numbering in the Drawings—The numbers in the drawings are usually, but not always, in sequential order.

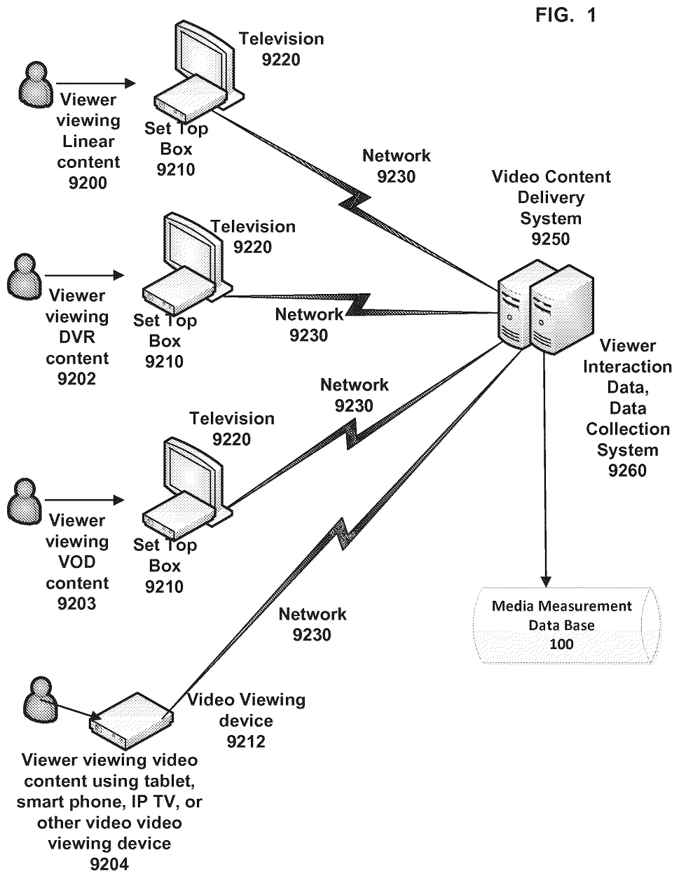

FIG. 1 provides an overview of an exemplary process for collecting viewer interaction data derived from a plurality of viewers interacting with video content that was delivered on a plurality of video asset viewing devices delivering content through a network and then loading that data to a Media Measurement Data Base 100. This figure illustrates several viewers interacting with video asset viewing devices to view content which was delivered to those devices across a network and then to collect viewing activity from those devices.

In this nonlimiting example, the purpose is not to describe in detail the operations of a video content delivery network or a data collection process, but simply to show how the data that is collected from that system can be made available to my MapReduce Aggregation Engine 200.

It begins with Viewer Viewing Linear Content 9200 who is interacting with a set-top box 9210 and television 9220 as he views linear content. The set-top box 9210 interacts with a Video Content Delivery System 9250 which delivers the content across a Network 9230.

It continues with Viewer Viewing DVR Content 9202 who is interacting with a set-top box 9210 and television 9220 as he interacts with DVR content, recording content and playing back recorded content using various modes including trick plays. The set-top box 9210 interacts with a Video Content Delivery System 9250 which delivers the content across a Network 9230.

It continues with Viewer Viewing VOD Content 9203 who is interacting with a set-top box 9210 and television 9220 as he interacts with VOD content, playing the content using various modes including trick plays. The set-top box 9210 interacts with a Video Content Delivery System 9250 which delivers the content across a Network 9230.

It continues with Viewer viewing video content using tablet, smart phone, IP TV, or other video video viewing device 9204 who is interacting with a variety of Video Viewing Devices 9212, including but not limited to tablet, smart phone, IP TV, PC, etc. The video viewing device interacts with a Video Content Delivery System 9250 which delivers the content across a Network 9230.

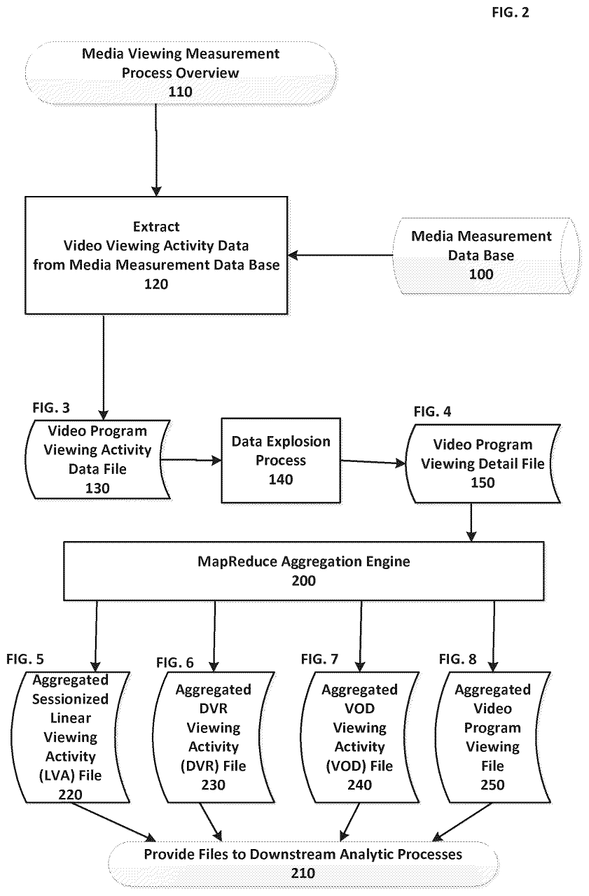

Video Content Delivery System 9250 then interacts with a Viewer Interaction Data, Data Collection System 9260 which collects all manner of viewer interaction data including Linear viewing including time-shifted linear viewing, Digital Video Recorder recording and playback/viewing, and Video on Demand viewing. The Viewer Interaction Data, Data Collection System 9260 then processes the data as needed to load it to a Media Measurement Data Base 100. The data in the Media Measurement Data Base 100 can then be used as input to my Aggregation Engine 200 as described in FIG. 2.

FIG. 2 illustrates an exemplary media measurement process from creation of the Video Program Viewing Activity Data File 130 to creation of the various aggregated viewing activity files (Parts 220, 230, 240, 250) which can then be provided to downstream analytic processes as shown by Provide Files to Downstream Analytic Processes 210.

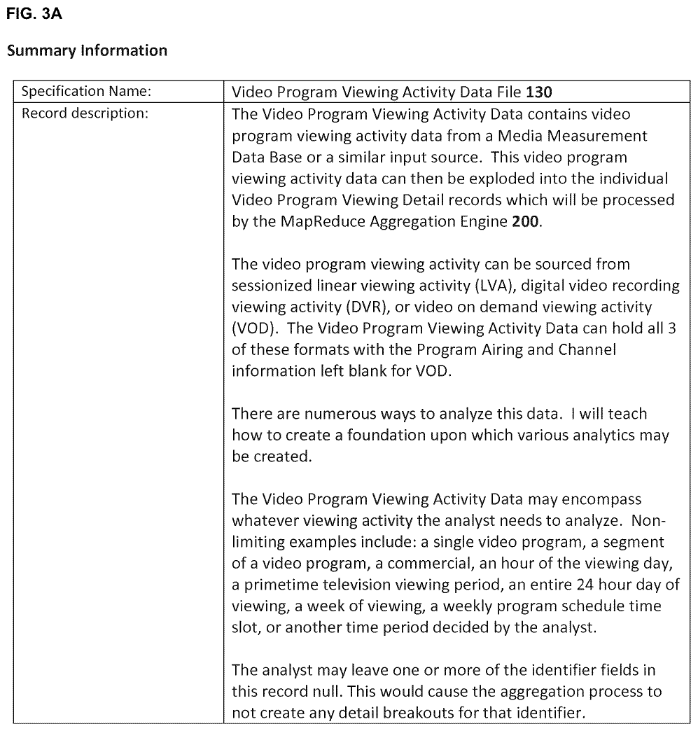

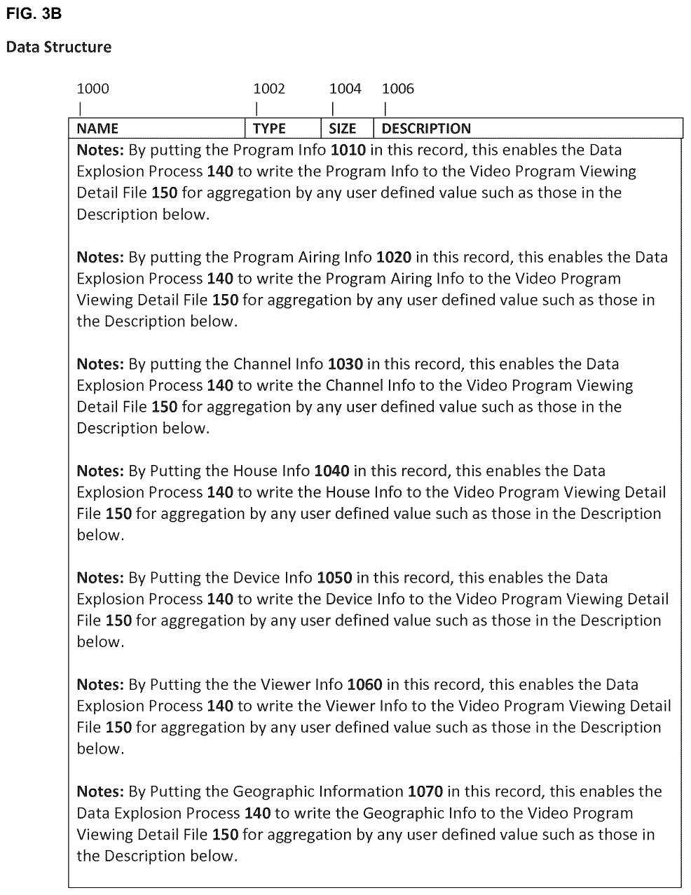

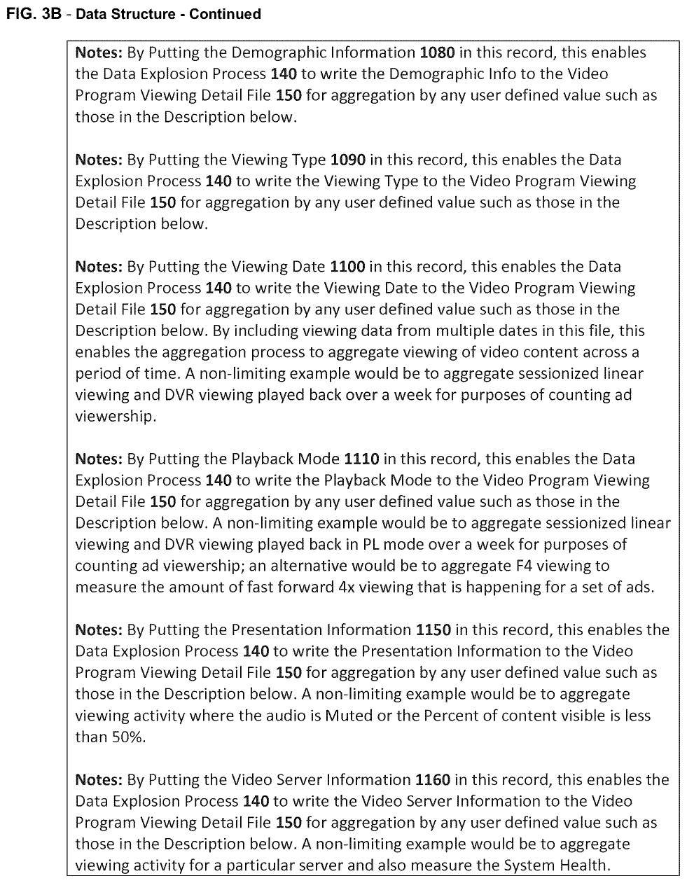

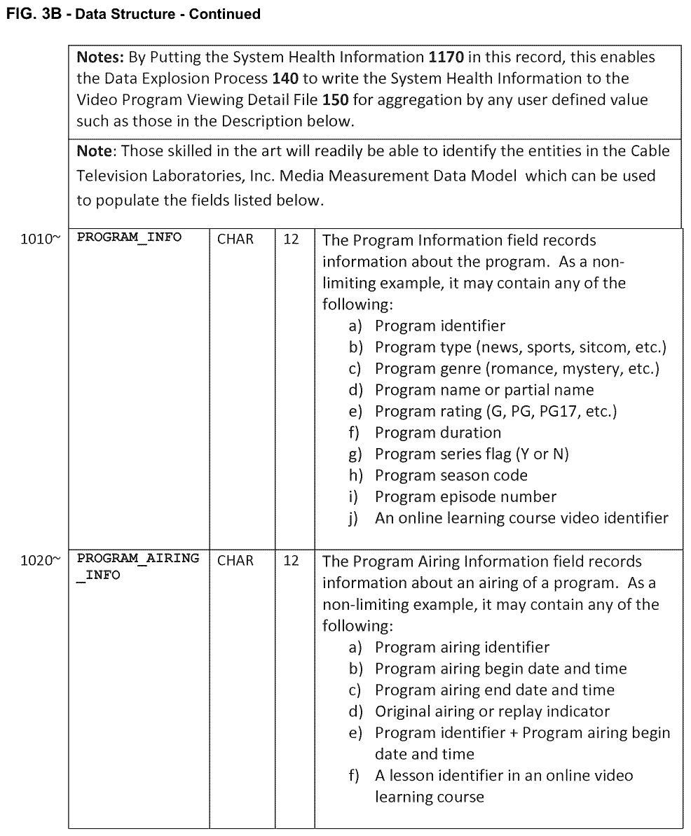

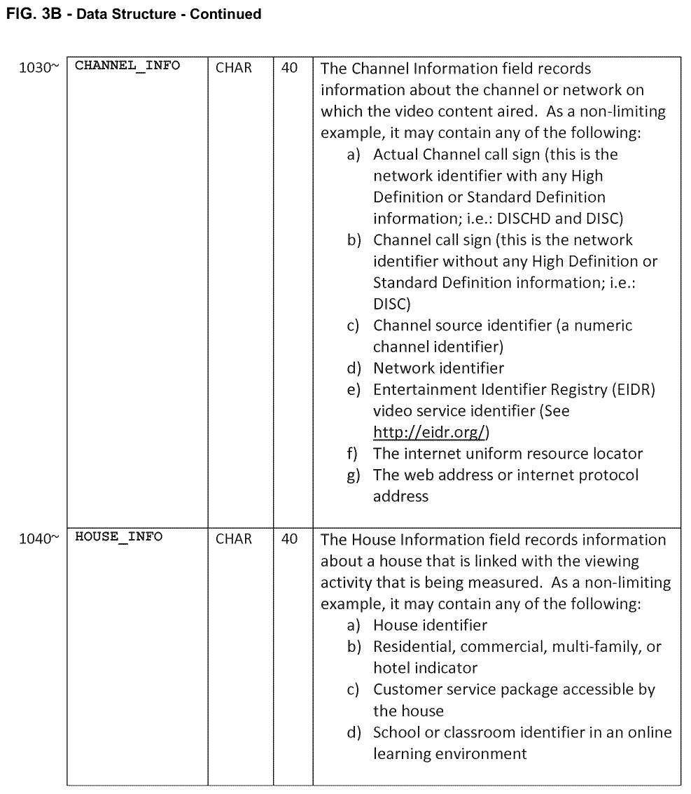

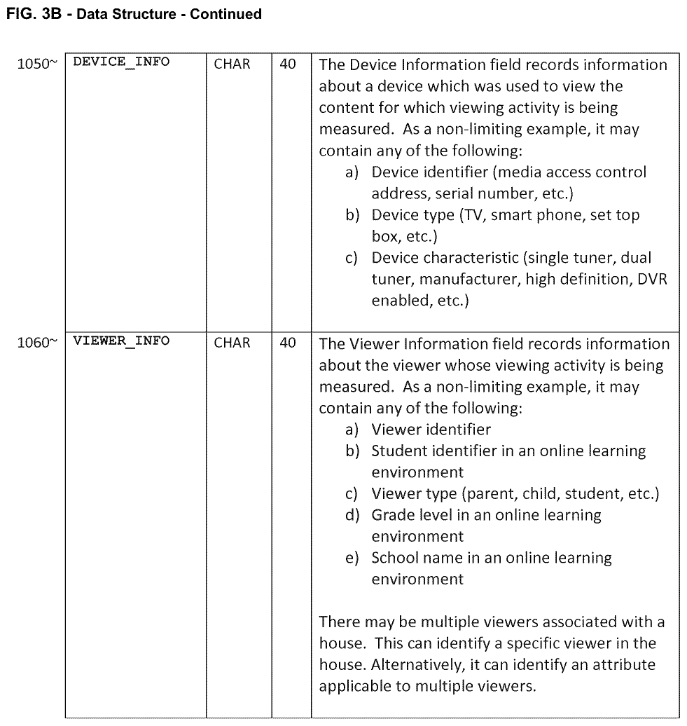

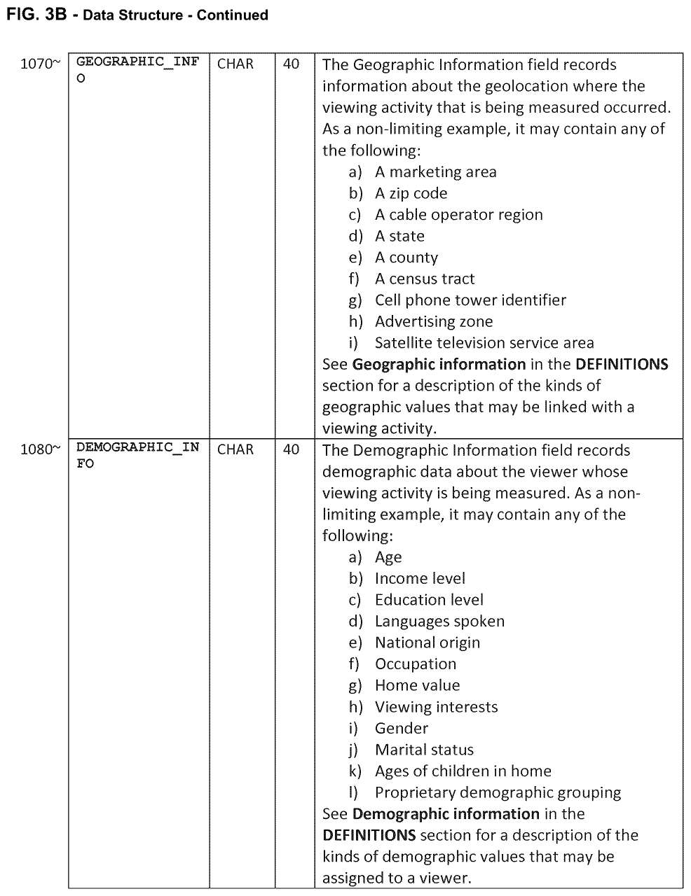

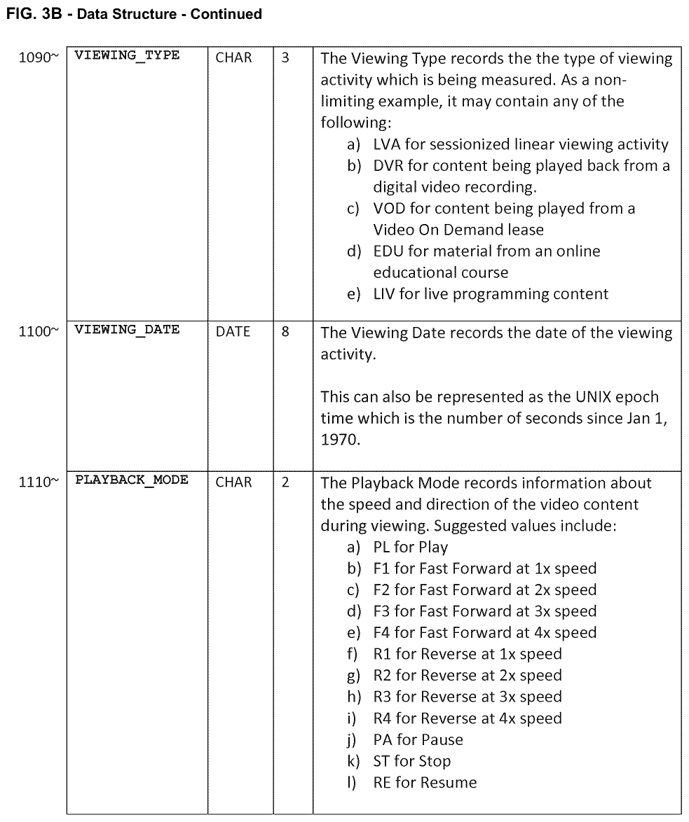

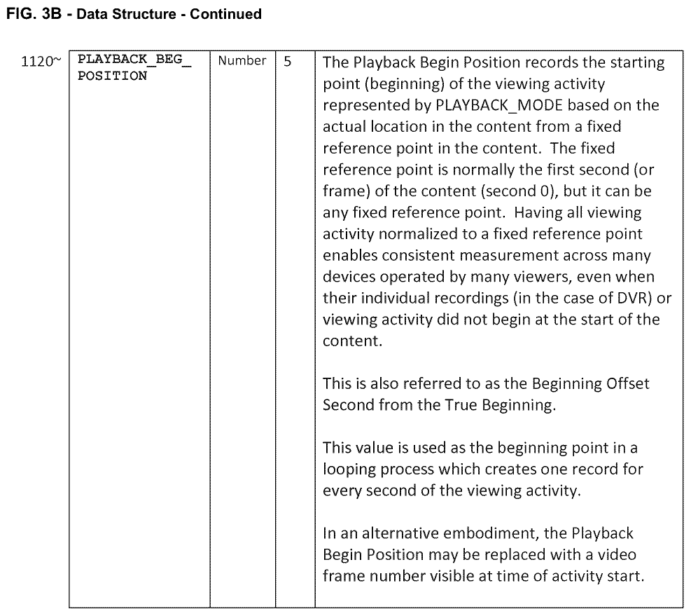

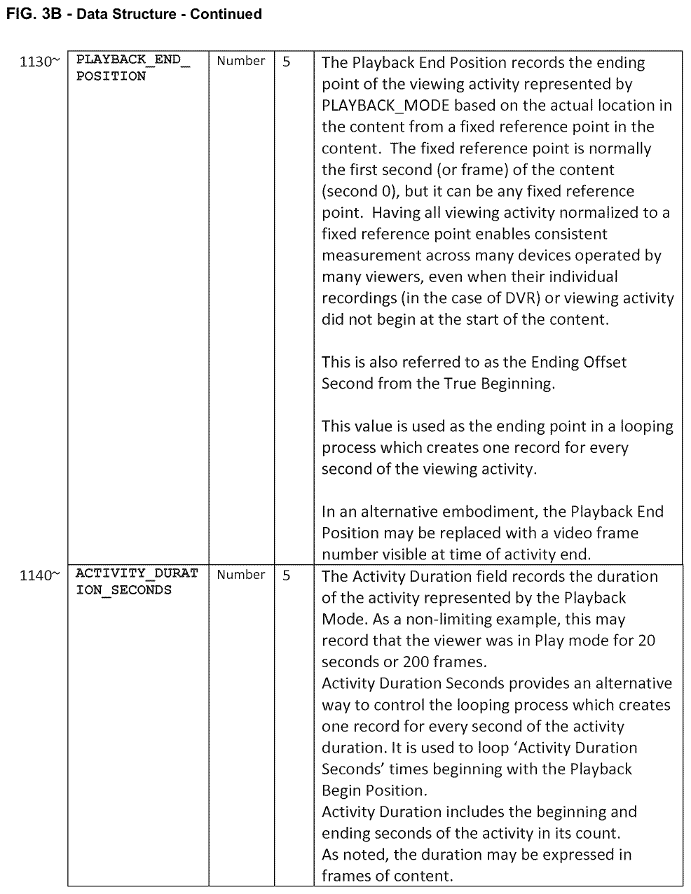

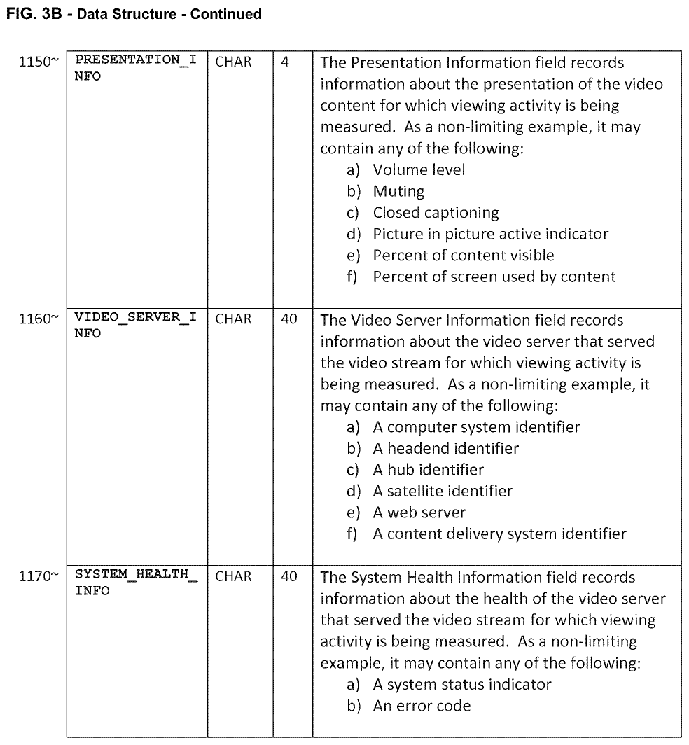

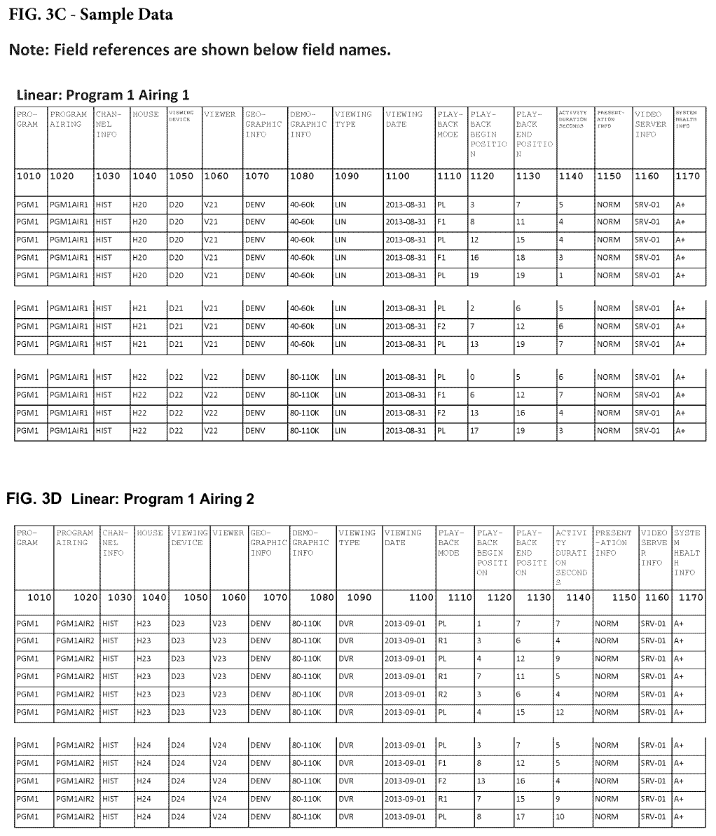

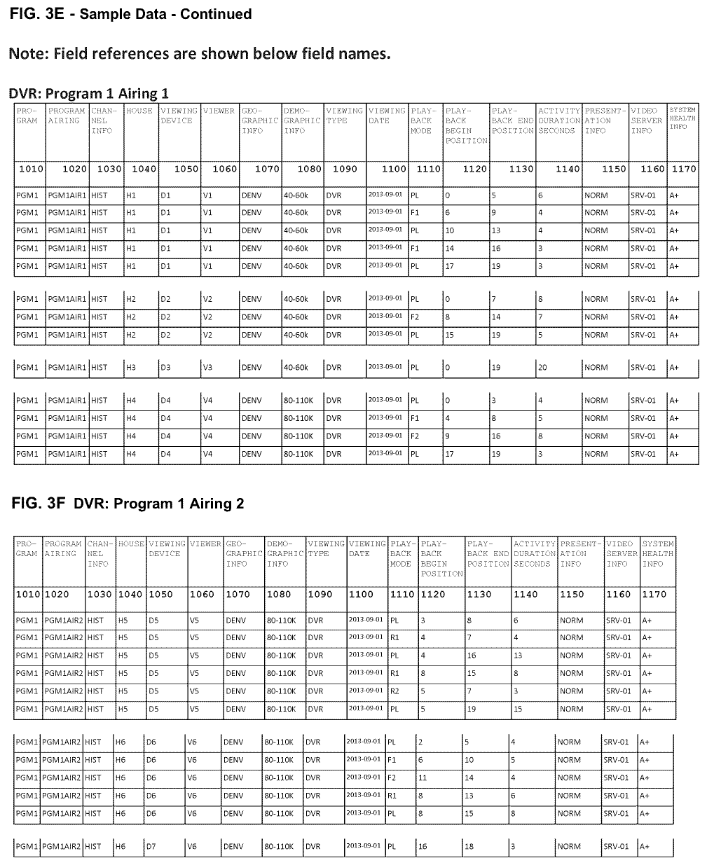

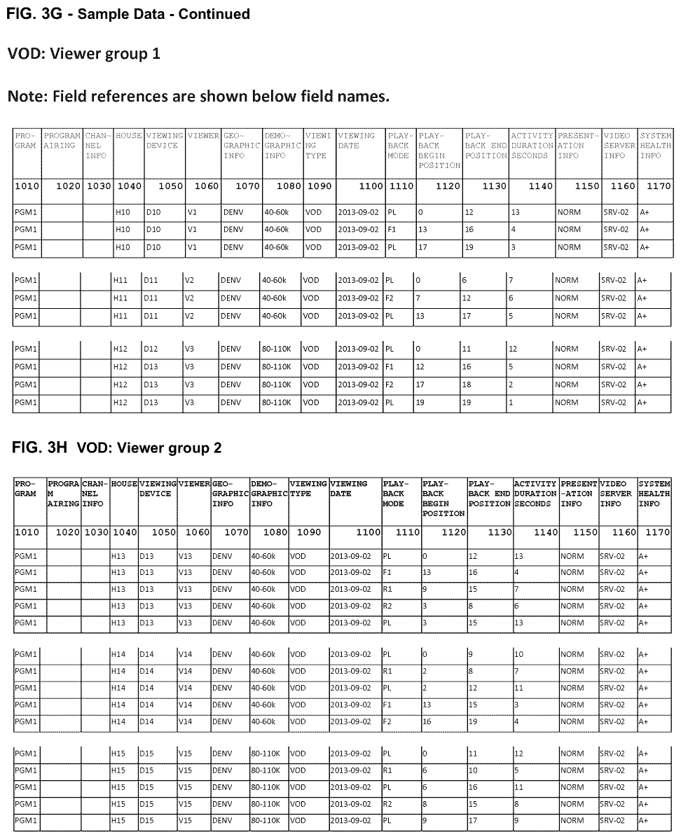

As noted previously, the video program viewing activity may be sourced from a Media Measurement Database such as the one described in the Cable Television Laboratories, Inc. specification. The populating of the Media Measurement Database 100 is beyond the scope of this application and so only brief remarks will be made in reference to that. There are video viewing data collection systems that are commonly used in the industry for collecting channel tuning or video viewing activity data including switched digital video systems, set top box applications, internet protocol video viewing applications, and other video viewing applications. I have discussed these in detail in my prior applications. These systems enable the collection of the video viewing events which can be loaded to a Media Measurement Database 100. From such a database, Video Program Viewing Activity Data can be extracted in a format similar to that shown in FIG. 3 Video Program Viewing Activity Data File 130.

Proceeding with the review of FIG. 2, the process begins with Media Viewing Measurement Process Overview 110. The first step is to extract the video viewing events as per Extract Video Viewing Activity Data from Media Measurement Data Base 120. Those skilled in the art will have no difficultly creating a database query or similar process to extract data from a Media Measurement Database 100 or other source and making it available in a format similar to that defined in Video Program Viewing Activity Data File 130. The file structure is defined in Video Program Viewing Activity Data File 130, as shown in FIGS. 3A-3H, which describes example formats for the input video program viewing activity data.

Resuming with the review of FIG. 2, those with reasonable skill in the art will readily recognize how to create the Video Program Viewing Activity Data File 130 (FIGS. 3A-3H). Note that there is a single record layout for LVA and DVR and VOD. In the case of VOD, the PROGRAM_AIRING_INFO 1020 and the CHANNEL_INFO 1030 may be left blank because these fields are not applicable to VOD.

The Video Program Viewing Activity Data File 130 can be provided by the Extract 120 process in any computer readable format including, but not limited to, database tables, flat files, JSON messages, and XML messages. Alternatively, such video viewing events can be collected directly from the source without the need for a Media Measurement Database 100. In such a case, those events can still be provided as video viewing activity in a format similar to that shown in FIGS. 3C-3H for use by the Data Explosion Process 140.

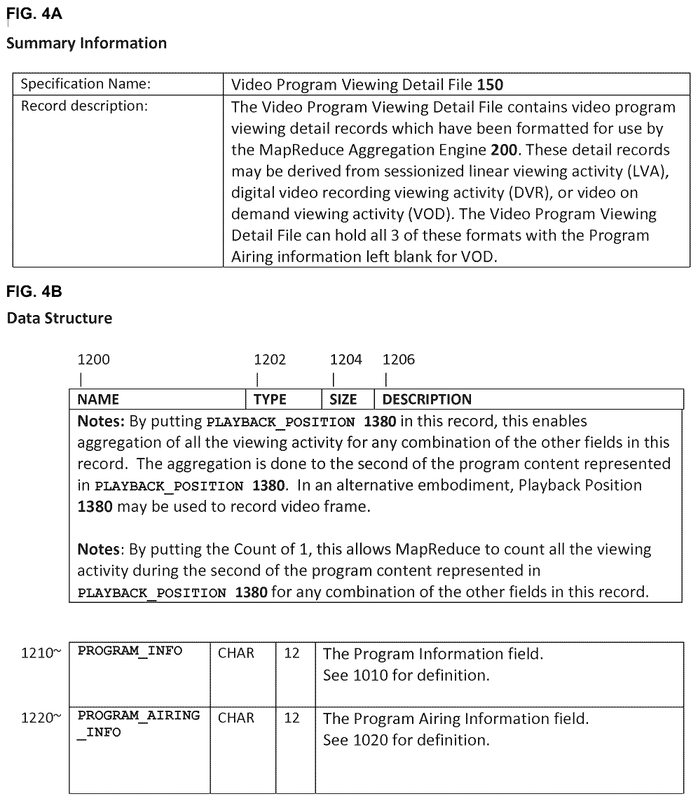

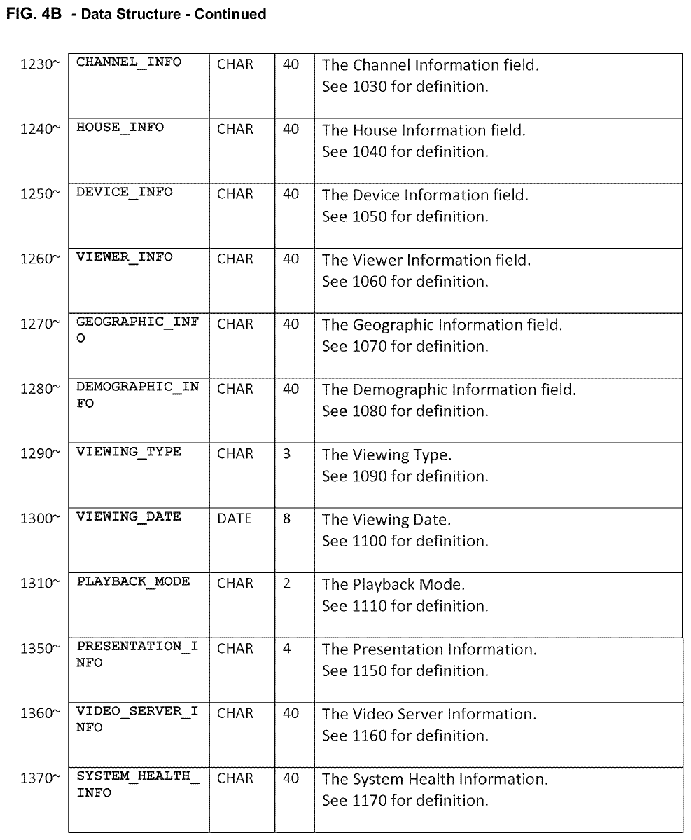

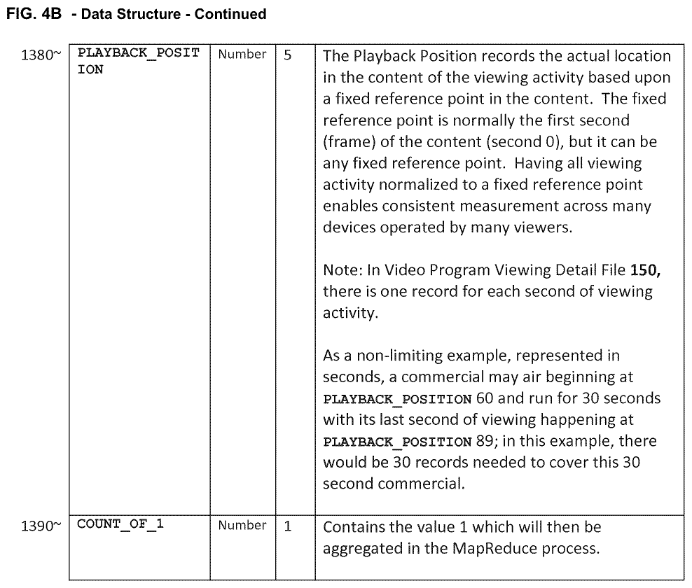

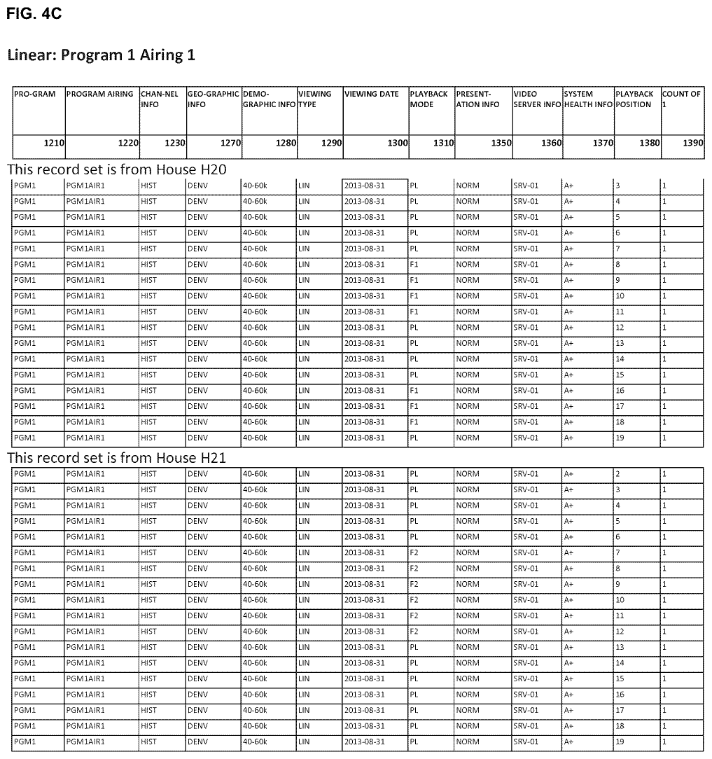

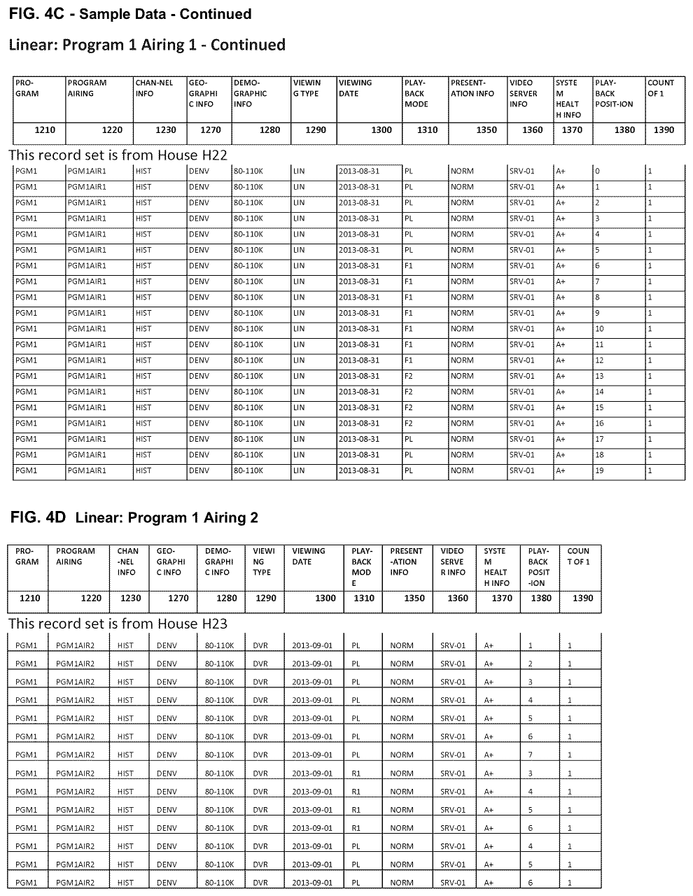

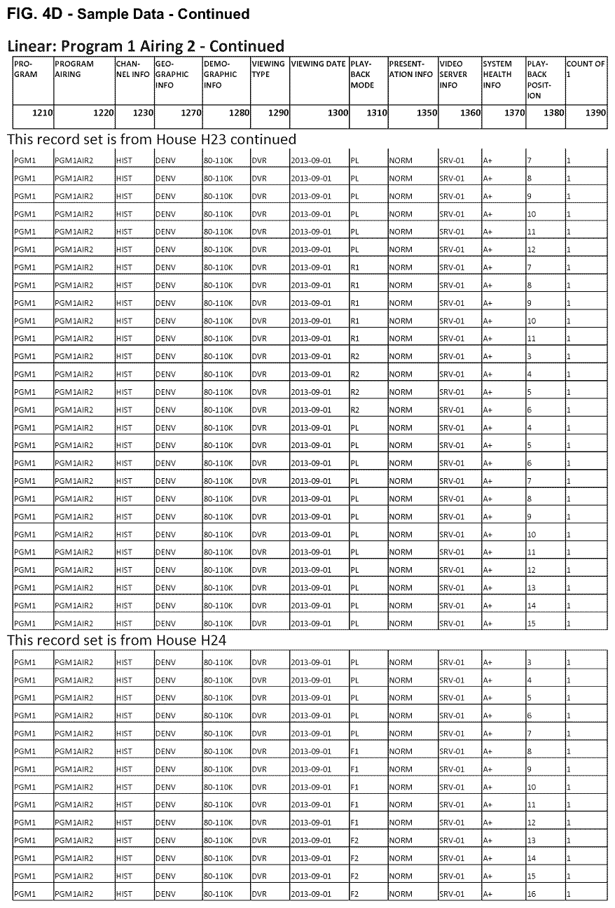

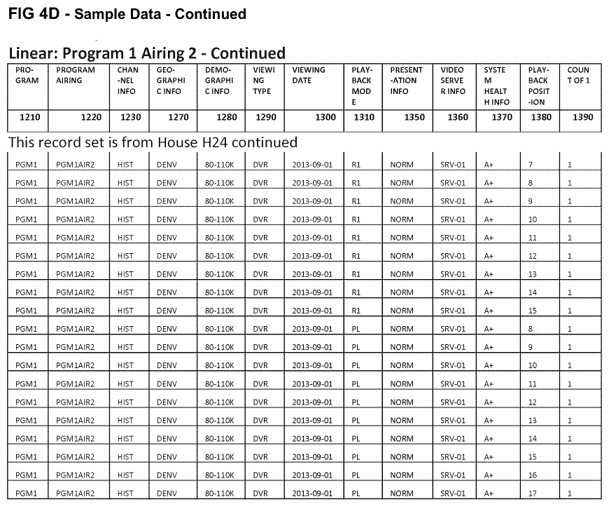

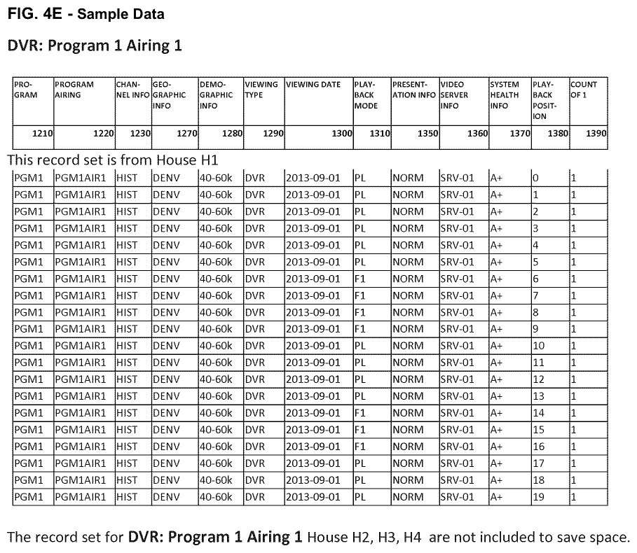

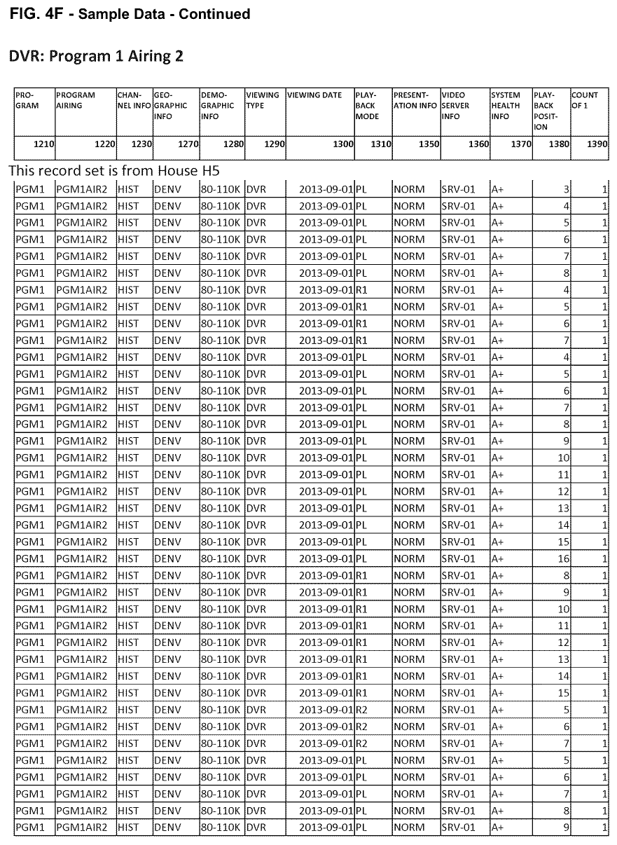

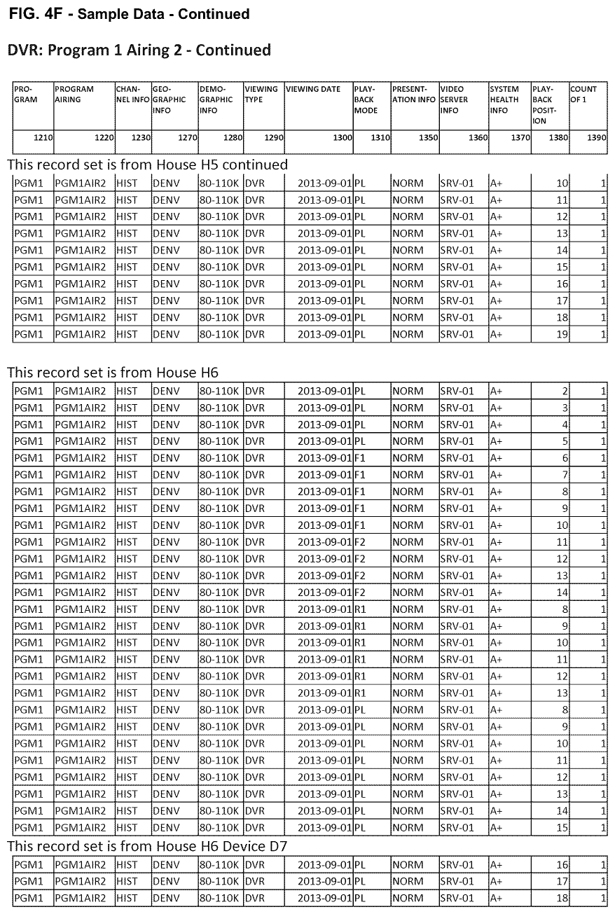

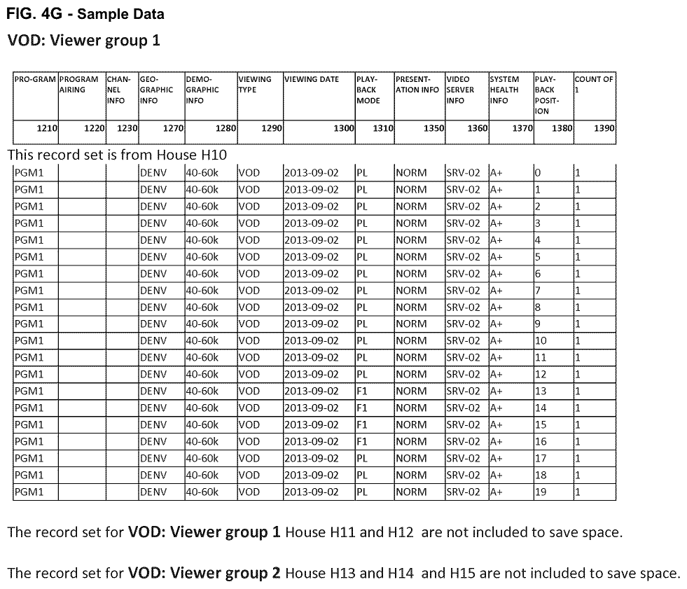

For each of these embodiments, at the completion of Data Explosion Process 140, one record has been written to the Video Program Viewing Detail File 150 for each second of the viewing duration represented in the video program viewing activity record. The Sample Data in FIGS. 3C-3H shows a non-limiting example of the input data for the Data Explosion Process 140. The Sample Data in FIGS. 4C-4G shows a non-limiting example of a partial set of the data produced by the Data Explosion Process 140. The reader will note that FIGS. 4G-4G sample data contains one record for every second of the viewing activity represented in the input data.

Those skilled in the art will readily recognize that the Data Explosion Process 140 is suitable for running in parallel on multiple computers simultaneously with each process creating Video Program Viewing Detail File records that can be fed into the MapReduce Aggregation Engine 200.

Proceeding with the review of FIG. 2, the Video Program Viewing Detail File 150 data residing in HDFS is now ready for use by the MapReduce Aggregation Engine 200. The MapReduce Aggregation Engine 200 runs various word count algorithms against the incoming data. Each word count algorithm will aggregate the data to a separate level as shown in FIG. 2 (Parts 220, 230, 240, 250) with the details shown in FIGS. 5A-8C.

The MapReduce process can be coded in JAVA or in Pig. I have coded this in Pig. The code below can be used to create the four output files reviewed in the Drawings (FIGS. 5A to 8C):

Note: A sample of the file created by the aggregation is shown in FIGS. 5C-5O Sample Data.

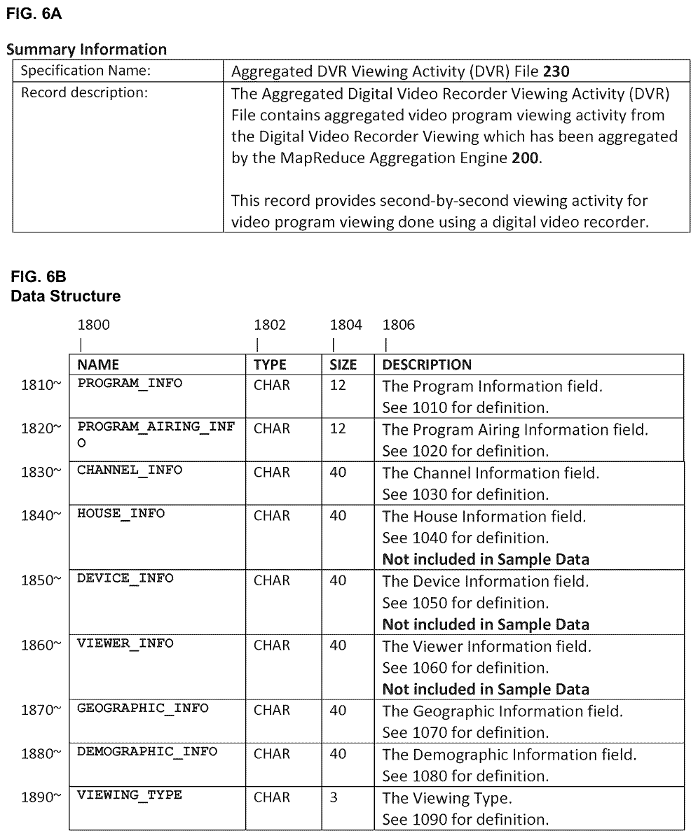

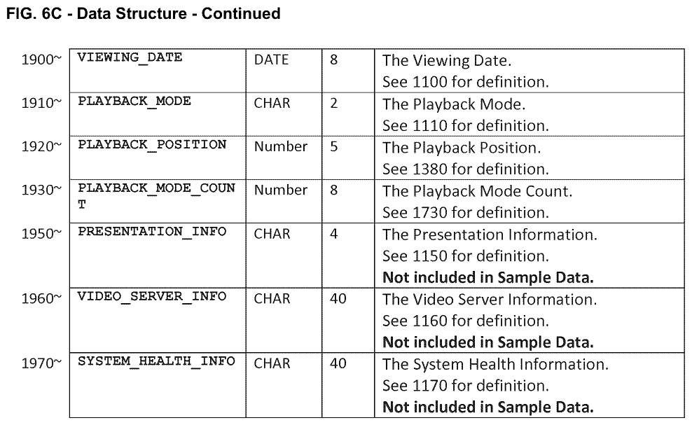

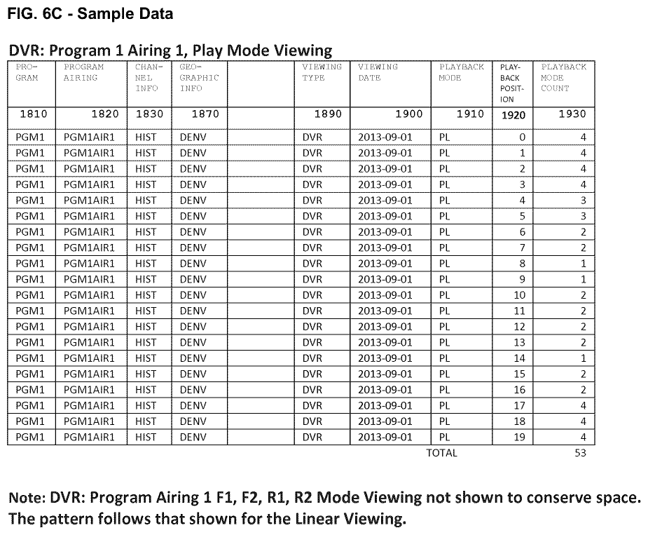

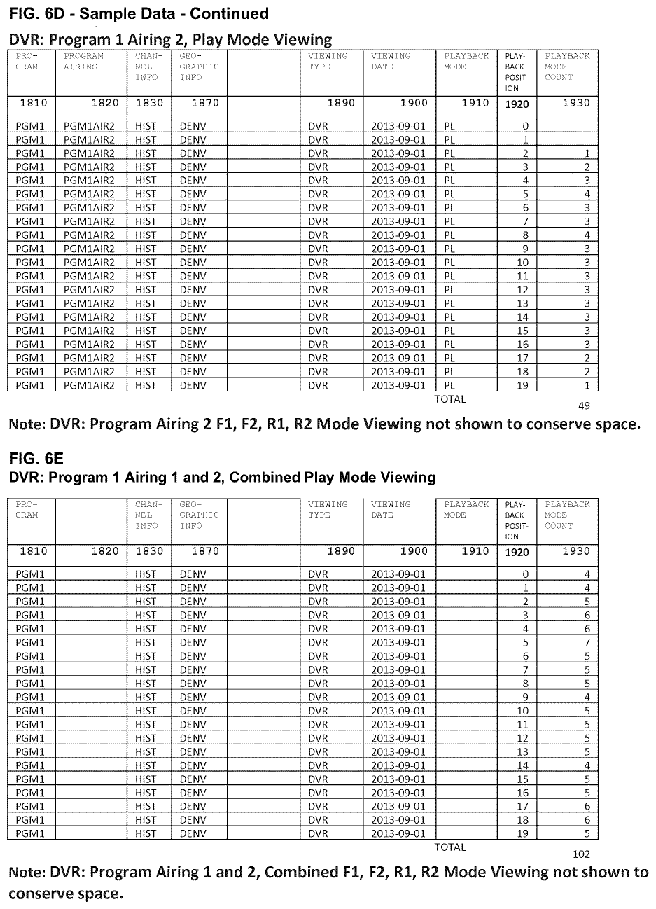

Note: A sample of the file created by the aggregation is shown in FIGS. 6C-6E Sample Data.

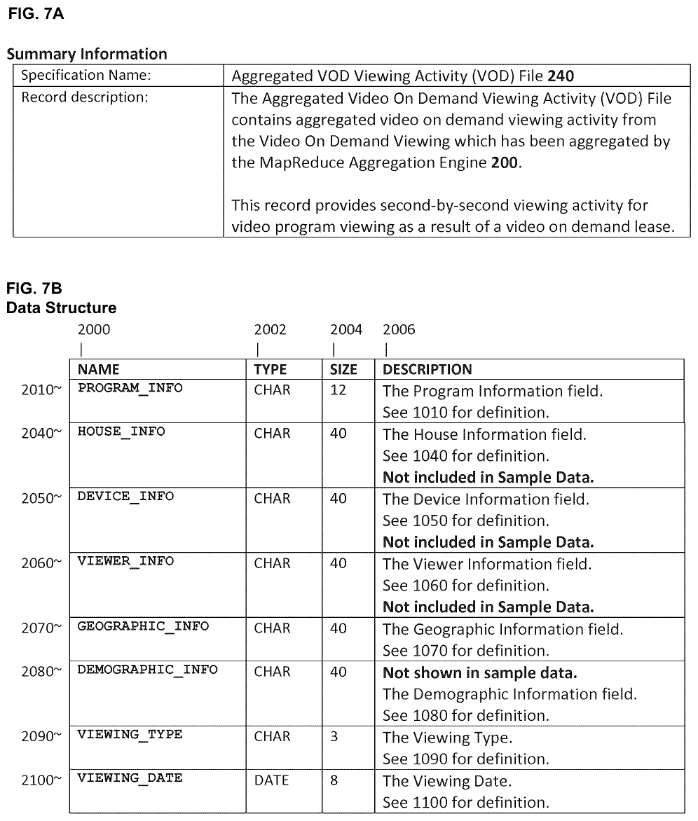

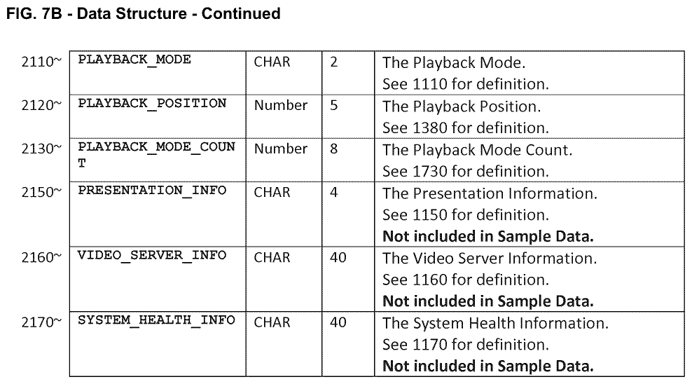

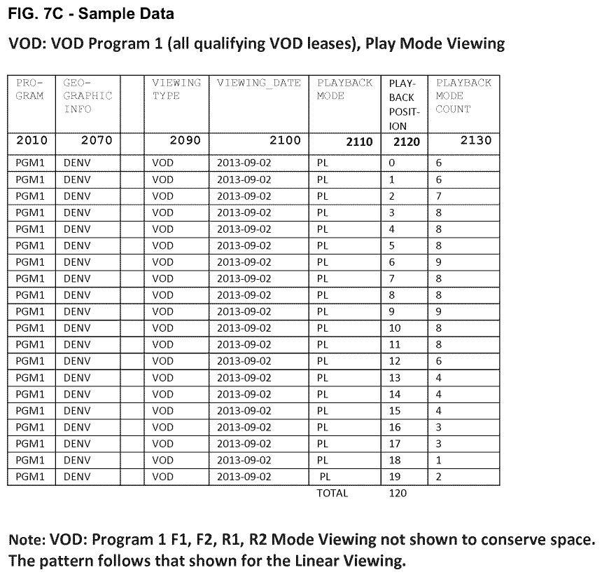

Note: A sample of the file created by the aggregation is shown in FIG. 7C Sample Data.

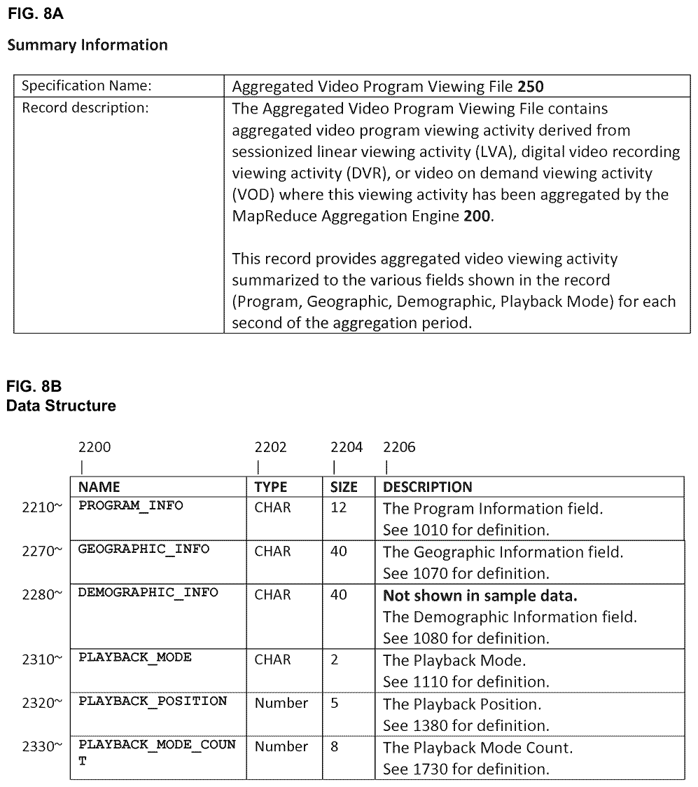

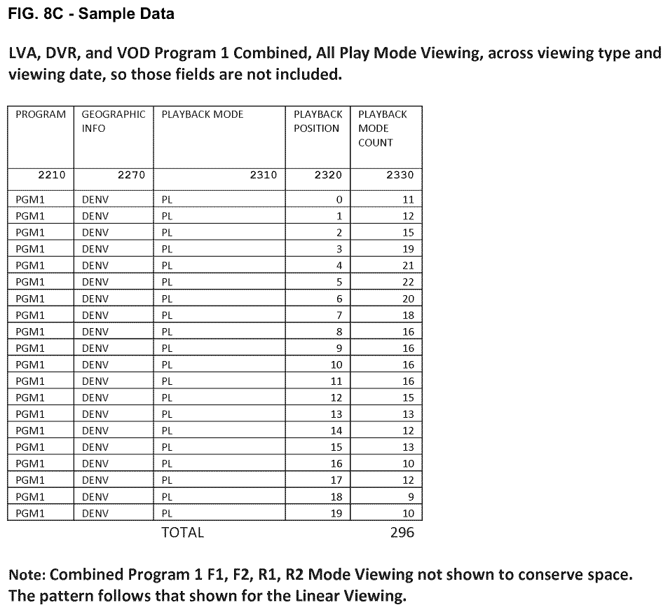

Note: A sample of the file created by the aggregation is shown in FIG. 8C Sample Data.

FIGS. 3A-3B illustrates example record layouts for a Video Program Viewing Activity Data File 130 record, formatted for use as input to the Data Explosion Process 140, and corresponding Data structure according to one embodiment. There is Summary Information followed by the Data Structure including field definitions, as shown in FIG. 3B. After the Data Structure there is a set of Sample Data, as shown for example in FIGS. 3C-3H.

### Discussion of FIGS. 3C-3H Sample Data

The FIGS. 3C-3H Sample Data contains the following breakouts:
Linear: Program 1 Airing
Linear: Program 1 Airing 2
DVR: Program 1 Airing 1
DVR: Program 1 Airing 2
VOD: Viewer group 1
VOD: Viewer group 2

In each case, the top row of the data table contains an abbreviated version of the field name. The second row of the chart contains the field number reference.

I have included enough sample data to clearly teach how the computer driven data explosion process will perform its task to generate the various detail records needed to represent the second-by-second viewing activity that is represented in the viewing activity data. Thus the reader will observe a variety of playback modes with varying durations.

Additionally, I have included two different program airings that are applicable to linear and DVR so that the aggregation process will then be able to aggregate across these to demonstrate what the computer is doing to achieve aggregation.

The FIGS. 3C-3H Sample Data will be carried forward to the other figures, where applicable, in this application.

FIGS. 4A-4B illustrate example record layouts for a Video Program Viewing Detail File 150 record, which is output from the Data Explosion Process 140, and corresponding Data structure according to one embodiment. This file is then ready for input to the MapReduce Aggregation Engine 200.

There is Summary Information followed by the Data Structure including field definitions, as shown in FIG. 4B. After the Data Structure there is a set of Sample Data, as shown for example in FIGS. 4C-4G.

### Discussion of FIGS. 4C-4G Sample Data

The FIGS. 4C-4G Sample Data contains the following breakouts:
Linear: Program 1 Airing 1
Linear: Program 1 Airing 2
DVR: Program 1 Airing 1
DVR: Program 1 Airing 2
VOD: Viewer group 1

This sample data does not contain all of the Program Viewing Detail records that are created by the Data Explosion Process based on the inputs in FIGS. 3A-3H. I have included enough sample data so that those skilled in the art will readily envision what the computer is doing to create this sample data. I have identified in FIGS. 4C-4G when data is not included.

### Overview of FIGS. 5A to 8C

FIGS. 5A to 8C review several outputs which are created by the MapReduce Aggregation Engine 200. There are multiple ways to aggregate the data depending upon the desired result. In FIGS. 5A to 8C I have shown several options. A person skilled in the art will readily identify additional aggregations options that fall within the spirit and scope of this Application.

FIG. 5A-5B illustrate example record layouts for an Aggregated Sessionized Linear Viewing Activity (LVA) File 220 record, which is output from the MapReduce Aggregation Engine 200, and corresponding Data structure according to one embodiment. This file is ready for input to downstream analytics processes. There is Summary Information followed by the Data Structure including field definitions, as shown in FIG. 5B. After the Data Structure there is a set of Sample Data, as shown for example in FIGS. 5C-5O.

### Discussion of FIGS. 5A-5O Sample Data

The FIG. 5C-5O Sample Data is organized to follow the pattern of the FIG. 4C-4G Sample Data. The reader will note the sample data is organized by Program 1 Airing 1 and then Program 1 Airing 2 and then Program 1 Airing 1 and Airing 2 combined. Within these groupings, there are sections for the various playback modes of PL, F1, F2, R1, R2 as they occur. The groupings are listed here:

FIGS. 6A-6B Illustrate example record layouts for an Aggregated DVR Viewing Activity (DVR) File 230 record, which is output from the MapReduce Aggregation Engine 200, and corresponding Data structure according to one embodiment. This file is ready for input to downstream analytics processes.

There is Summary Information followed by the Data Structure including field definitions, as shown in FIG. 6B. After the Data Structure there is a set of Sample Data, as shown for example in FIGS. 6C-6E.

### Discussion of FIGS. 6C-6E Sample Data

The FIGS. 6C-6E Sample Data is organized to follow the pattern of the FIG. 4C-4G Sample Data.

The reader will note the sample data is organized by Program 1 Airing 1 and then Program 1 Airing 2 and then Program 1 Airing 1 and 2 combined. Within these groupings, there are sections for only playback mode of PL to conserve space (playback modes F1, F2, R1, R2 are not shown). The pattern of how to aggregate this data is very similar to that shown in FIGS. 5C-5O, so the reader should have no difficulty in understanding this process. The groupings are listed here:

FIGS. 7A-7B Illustrate example record layouts for an Aggregated VOD Viewing Activity (VOD) File 240 record, which is output from the MapReduce Aggregation Engine 200, and corresponding Data structure according to one embodiment. This file is ready for input to downstream analytics processes.

There is Summary Information followed by the Data Structure including field definitions, as shown in FIG. 7B. After the Data Structure there is a set of Sample Data, as shown for example in FIG. 7C.

### Discussion of FIG. 7C Sample Data

The FIG. 7C Sample Data is organized to follow the pattern of the FIG. 4C-4G Sample Data. The reader will note the sample data is organized to show VOD Program 1 (all qualifying VOD leases) which illustrates how the computer would aggregate VOD viewing for a program across multiple homes and/or devices to produce the aggregated second-by-second viewing activity for a program for each playback mode.

This output file has value on its own, or it can be loaded to a data store for additional downstream analytics.

FIGS. 8A-8B Illustrate example record layouts for an Aggregated Video Program Viewing File 250 record, which is output from the MapReduce Aggregation Engine 200, and corresponding Data structure according to one embodiment. This file is ready for input to downstream analytics processes.

There is Summary Information followed by the Data Structure including field definitions, as shown in FIG. 8B. After the Data Structure there is a set of Sample Data, as shown for example in FIG. 8C.

### Discussion of FIG. 8C Sample Data

The FIG. 8C Sample Data is organized to follow the pattern of the FIG. 4C-4G Sample Data. The reader will note the sample data is organized to show LVA, DVR, and VOD Program 1 Combined which illustrates how the computer would aggregate LVA, DVR, and VOD viewing for a program across multiple homes and/or devices to produce the aggregated second-by-second viewing activity for a program for each playback mode.

This output file has value on its own, or it can be loaded to a data store for additional downstream analytics.

### Alternative Embodiments

Although the description above contains much specificity, this should not be construed as limiting the scope of the embodiments but as merely providing illustrations of some of several embodiments. As a nonlimiting example, additional qualifiers may be added along with those provided. Additional aggregations can be done using other combinations of these identifiers.

### Scope of Viewer Interaction Data Loaded

I presently contemplate that the MapReduce Aggregation Engine 200 will process viewer interaction data for whatever set of viewing activity is provided to it. This may be one Video Program at a time, one hour of the day, a primetime television viewing period, an entire 24 hour day of viewing, a week of viewing, a weekly program schedule time slot, or another time period decided by the analyst. Another embodiment may simply process viewing activity within the context of a single program, or a single advertisement, or some other combination.

### Use of Hadoop and MapReduce

I presently contemplate that the MapReduce Aggregation Engine 200 will take advantage of Hadoop MapReduce technology. Another embodiment may load the Video Program Viewing Detail records to a relational database and run various SQL queries to produce results similar to those shown.

### Data Explosion Process

I presently contemplate that the Data Explosion Process 140 will generate one record for each second of viewing activity with the field Count_of_1 1390 having a value of 1. This method provides flexibility in terms of possible data aggregation, but it does consume more resources to process all the records. In another embodiment logic could be added to the Data Explosion Process 140 so that various records end up with a count of 2 or 3 or some higher number reflecting that multiple devices were viewing that content. The outcome is that fewer records would be sent into the MapReduce Aggregation Engine 200 thus reducing the load on the system.

### Identifiers for Data

I presently contemplate using a combination of numeric and mnemonics for the various fields such as program info, program airing info, channel info, house info, device info, viewer info, geographic info, demographic info, viewing type, video server identifiers, system health info, and other similar fields, but another embodiment could use only numeric values as identifiers with links to reference tables for the descriptions of the numeric identifiers or only mnemonic identifiers.

### Data Explosion Process

I presently contemplate that the Data Explosion Process 140 will generate one record for each second of the tuning activity. Another embodiment may generate one record for each video frame of viewing activity. In this case, the playback begin position and playback end position would be replaced by a frame number for each of these fields.

Yet another embodiment may generate records at a one minute level with the count being the number of seconds tuned to the content during that minute (in this case there would be 1,440 possible one minute intervals during a 24 hour day).

Yet another embodiment may generate records at a 10-second level with the count being the number of seconds tuned to the content during that 10-second interval (in this case there would be 8,640 possible 10-second intervals during a 24 hour day).

### Programming Algorithm Scope

I presently contemplate executing the algorithms described herein separately in some sequence, but another embodiment could combine multiple simple algorithms into fewer complex algorithms.

### Receiving Date and Time Information

I presently contemplate receiving all of the date and time values in local time, but another embodiment may provide these in Coordinated Universal Time (UTC time).

### General Information

I presently contemplate using variables having the data types and field sizes shown, but another embodiment may use variables with different data types and field sizes to accomplish a similar result.

I presently contemplate tracking viewing activity at the granularity of one second, but another embodiment may track viewing activity at a finer granularity, perhaps half-second, or tenth-second, or millisecond. Yet another embodiment may receive data at a granularity finer than one second and round to the nearest second for use by the MapReduce Aggregation Engine 200.

I presently contemplate using record layouts similar to those defined herein, but another embodiment may use a different record layout or record layouts to accomplish a similar result. As a nonlimiting example, another embodiment may use database tables or other objects instead of record layouts similar to those I have defined herein to accomplish a similar result while still working within the spirit and scope of this disclosure.

### Implementation Information

I presently contemplate using the generic Apache Hadoop distribution, but another embodiment may use a different Hadoop distribution.

I presently contemplate using Linux operating system, but another embodiment may use a different operating system.

I presently contemplate using the Pig along with the Pig Latin dataflow language, but another embodiment may use Java or Python or some other language alone or in combination with Pig Latin.

### General Remarks

It will be apparent to those of ordinary skill in the art that various changes and modifications may be made which clearly fall within the scope of the embodiments revealed herein. In describing an embodiment illustrated in the drawings, specific terminology has been used for the sake of clarity. However, the embodiments are not intended to be limited to the specific terms so selected, and it is to be understood that each specific term includes all technical equivalents which operate in a similar manner to accomplish a similar purpose.

In general, it will be apparent to one of ordinary skill in the art that various embodiments described herein, or components or parts thereof, may be implemented in many different embodiments of software, firmware, and/or hardware, or modules thereof. The software code or specialized control hardware used to implement some of the present embodiments is not limiting of the present embodiment. For example, the embodiments described hereinabove may be implemented in computer software using any suitable computer software language type such as, for example, Python or JAVA using, for example, conventional or object-oriented techniques. Such software may be stored on any type of suitable computer-readable medium or media such as, for example, a magnetic or optical storage medium. Thus, the operation and behavior of the embodiments are described in Pig Latin dataflow language purely as a matter of convenience. It is clearly understood that artisans of ordinary skill would be able to design software and control hardware to implement the embodiments presented in the language of their choice based on the description herein with only a reasonable effort and without undue experimentation.

The processes associated with the present embodiments may be executed by programmable equipment, such as computers. Software or other sets of instructions that may be employed to cause programmable equipment to execute the processes may be stored in any storage device, such as, for example, a computer system (non-volatile) memory, a compact disk, an optical disk, magnetic tape, or magnetic disk. Furthermore, some of the processes may be programmed when the computer system is manufactured or via a computer-readable medium.

It can also be appreciated that certain process aspects disclosed herein may be performed using instructions stored on a computer-readable memory medium or media that direct a computer or computer system to perform process steps. A computer-readable medium may include, for example, memory devices such as diskettes, compact discs of both read-only and read/write varieties, optical disk drives, memory sticks, and hard disk drives. A computer-readable medium may also include memory storage that may be physical, virtual, permanent, temporary, semi-permanent and/or semi-temporary.

In various embodiments disclosed herein, a single component or algorithm may be replaced by multiple components or algorithms, and multiple components or algorithms may be replaced by a single component or algorithm, to perform a given function or functions. Except where such substitution would not be operative to implement the embodiments disclosed herein, such substitution is within the scope presented herein. Thus any element expressed herein as a means or a method for performing a specified function is intended to encompass any way of performing that function including, for example, a combination of elements that performs that function. Therefore, any means or method that can provide such functionalities may be considered equivalents to the means or methods shown herein.

It can be appreciated that the “data analysis computer system” may be, for example, any computer system capable of running MapReduce, whether it be a one node system or a system with thousands of nodes. In an alternative embodiment, it may be a relational database server.

While various embodiments have been described herein, it should be apparent, however, that various modifications, alterations and adaptations to those embodiments may occur to persons skilled in the art with the attainment of some or all of the advantages described herein. The disclosed embodiments are therefore intended to include all such modifications, alterations and adaptations without departing from the scope and spirit of the embodiments presented herein as set forth in the appended claims.

Accordingly, the scope should be determined not by the embodiments illustrated, but by the appended claims and their legal equivalents.

### Conclusions, Ramifications, and Scope

In my previous Applications, I have identified numerous Conclusions, Ramifications, and Scope items. Many of those are similar for this application. The Conclusions, Ramifications, and Scope items from my U.S. Pat. No. 8,365,212 B1 issued on Jan. 29, 2013, and my U.S. Pat. No. 8,365,213 B1 issued on Jan. 29, 2013, and my U.S. application Ser. No. 13/360,704 filed on Jan. 28, 2012, and my U.S. application Ser. No. 13/567,073 filed on Aug. 5, 2012 and my U.S. application Ser. No. 13/740,199 filed on Jan. 13, 2013 are included herein by reference but not admitted to be prior art.

In this discussion below, I will focus on new ramifications introduced by this application.

From the description above, a number of advantages of some embodiments of my MapReduce Aggregation Engine 200 and its supporting processes become evident:

In this specification I have taught how to measure or analyze video program viewing activity at a second-by-second level using the Hadoop MapReduce framework. This teaching allows measurement of linear program viewing, DVR viewing, and VOD viewing with the ability to understand how the viewer uses “trick plays” when viewing this content. This insight gained from this can be valuable to advertisers, content producers, and content providers. As a non-limiting example, this provides detailed measurements into the amount of fast forward activity that occurs during commercials. Additionally, by teaching how to include numerous identifiers and then aggregate the detailed viewing activity to various combinations of those identifiers, an analyst will now be able to slice-and-dice the data in numerous ways to understand how different content is consumed by various people in various geographic locations.

Once the metrics are calculated, the resulting files can be loaded to a database for longitudinal analysis. As a nonlimiting example, the program level metrics can be tracked to identify week-to-week activity such as, for example, total seconds viewed in Play mode. Then the more detailed metrics can provide additional insight into the causes behind the overall trends.

The ability to produce these metrics using the Hadoop MapReduce framework provides a new tool for data analysts to use in understanding viewing behavior.

This method of using the Hadoop MapReduce framework to calculate second-by-second viewing activity for program based viewing such as linear, DVR, and VOD by aggregating individual viewing records that were created by exploding the viewing period into individual records where each record represents one second of viewing activity is contrary to the teaching of those who work with start time and duration (seconds viewed). Thus I am able to solve problems previously found insolvable when limited to using the existing techniques. I am able to provide metrics that could not be produced using existing techniques.

Additionally, I have shown how this teaching is application to online education for use in analyzing video viewing in that context.

### Subsequent Usage of the Metrics

The metrics produced by the MapReduce Aggregation Engine 200 readily lend themselves to dimensional analysis using contemporary data warehouse methods. I have reviewed this extensively in my prior applications.

The metrics produced by the MapReduce Aggregation Engine 200 can be loaded to a data warehouse to support additional longitudinal analysis beyond what is done by the Engine 200. Thus we can readily envision a myriad of uses for the metrics produced by the MapReduce Aggregation Engine 200.

Numerous additional metrics can readily be identified by those skilled in the art. Additionally, numerous additional uses for the metrics identified herein will be readily evident to those skilled in the art.

### SUMMARY

In accordance with one embodiment, I have disclosed a computer-implemented method of using video program viewing activity data as input to an aggregation engine built on the Hadoop MapReduce framework which calculates second-by-second video viewing activity for Linear, DVR, and VOD program level viewing including measuring trick play activity with results aggregated to the analyst's choice of program, program airing, channel, house attributes, device attributes, geographic area, demographic attributes, viewing date, or any combination of these fields, for each second of program content represented in the video program viewing data. The source data may be extracted from a database defined according to the Cable Television Laboratories, Inc. Media Measurement Data Model defined in “Audience Data Measurement Specification” as “OpenCable.™. Specifications, Audience Measurement, Audience Measurement Data Specification” document OC-SP-AMD-101-130502 or any similar format. These metrics provide detailed data needed to calculate information on customer viewing behavior that can drive business decisions for service providers, advertisers, and content producers. The ability to use the Hadoop MapReduce framework to aggregate this data will meet pressing needs for detailed audience viewership information that is not presently available and thus the metrics will be of great value to the industry.

1. A method comprising:
creating, by a computing system, a data structure comprising data records representing discrete time periods associated with video-viewing activity;
based on video-viewing-activity data received from a plurality of devices, assigning by the computing system, to one or more data records of the data structure, values indicating at least one of a video-viewing mode, of a plurality of viewing modes, or a video-viewing type of a plurality of video-viewing types;
for each device of the plurality of devices:
determining, by the computing system, a plurality of time intervals of a time range during which the device outputted a video asset; and
using the data structure to determine, by the computing system and based on a video-viewing type and a video-viewing mode associated with each of the plurality of time intervals determined for the device, a subset plurality of time intervals associated with a first video-viewing type and a first video-viewing mode;
determining, by the computing system and based on data records, of the data structure, associated with the subset plurality of time intervals, a video-viewing-activity metric indicating a quantity of devices that outputted, during one or more intervals of a plurality of intervals of the video asset, the video asset using the first video-viewing type and the first video-viewing mode; and
outputting, by the computing system, an indication of the determined video-viewing-activity metric.

2. The method of claim 1, wherein the video asset comprises an advertisement.

3. The method of claim 1, wherein the video-viewing type comprises at least one of linear viewing, digital video recorder (DVR) viewing, or video on demand (VOD) viewing.

4. The method of claim 1, further comprising:
determining, based on the data records and for each time interval of the plurality of time intervals, one of a playback mode, a fast-forward mode, or a rewind mode.

5. The method of claim 1, further comprising:
using the data structure to determine, by the computing system and based on the plurality of time intervals determined for each device of the plurality of devices, a quantity of devices that outputted, during the one or more intervals of the plurality of intervals of the video asset, the video asset using the first video-viewing type and a second video-viewing mode.

6. The method of claim 1, wherein:
each time interval of the plurality of time intervals determined for a first device of the plurality of devices is associated with the first video-viewing type; and
each time interval of the plurality of time intervals determined for a second device of the plurality of devices is associated with a second video-viewing type different from the first video-viewing type.

7. The method of claim 1, wherein:
the time range determined for a first device of the plurality of devices is associated with a first airing of the video asset; and
the time range determined for a second device of the plurality of devices is associated with a second airing of the video asset.

8. The method of claim 1, wherein a video-viewing type, of the plurality of video-viewing types, comprises digital video recorder viewing.

9. The method of claim 1, wherein a video-viewing type, of the plurality of video-viewing types, comprises linear viewing.

10. An apparatus comprising:
one or more processors; and
memory storing instructions that, when executed by the one or more processors, cause the apparatus to:
create a data structure comprising data records representing discrete time periods associated with video-viewing activity;
based on video-viewing-activity data received from a plurality of devices, assign, to one or more data records of the data structure, values indicating at least one of a video-viewing mode, of a plurality of viewing modes, or a video-viewing type of a plurality of video-viewing types;
for each device of the plurality of devices:
determine a plurality of time intervals of a time range during which the device outputted a video asset; and
use the data structure to determine, based on a video-viewing type and a video-viewing mode associated with each of the plurality of time intervals determined for the device, a subset plurality of time intervals associated with a first video-viewing type and a first video-viewing mode;
determine, based on data records, of the data structure, associated with the subset plurality of time intervals, a video-viewing-activity metric indicating a quantity of devices that outputted, during one or more intervals of a plurality of intervals of the video asset, the video asset using the first video-viewing type and the first video-viewing mode; and
output an indication of the determined video-viewing-activity metric.

11. The apparatus of claim 10, wherein the instructions, when executed by the one or more processors, cause the apparatus to:
use the data structure to determine a video-viewing type by determining whether the video asset was outputted from a linear source, from a digital video recorder (DVR) source, or from a video on demand (VOD) source.

12. The apparatus of claim 10, wherein the instructions, when executed by the one or more processors, cause the apparatus to:
determine, based on the data records and for each time interval of the plurality of time intervals, one of a playback mode, a fast-forward mode, or a rewind mode.

13. The apparatus of claim 10, wherein the instructions, when executed by the one or more processors, cause the apparatus to:
use the data structure to determine, based on the plurality of time intervals determined for each device of the plurality of devices, a quantity of devices that outputted, during the one or more intervals of the plurality of intervals of the video asset, the video asset using the first video-viewing type and a second video-viewing mode.

14. The apparatus of claim 10, wherein the instructions, when executed by the one or more processors, cause the apparatus to use the data structure to determine a video-viewing mode by determining, for each time interval of the plurality of time intervals determined for the device, one of a playback mode, a fast-forward mode, or a rewind mode.

15. The apparatus of claim 10, wherein the video asset comprises an advertisement.

16. A system comprising:
a computing device comprising:
one or more first processors; and
first memory storing first instructions that, when executed by the one or more first processors, cause the computing device to:
create a data structure comprising data records representing discrete time periods associated with video-viewing activity;
based on video-viewing-activity data received from a plurality of devices, assign, to one or more data records of the data structure, values indicating at least one of a video-viewing mode, of a plurality of viewing modes, or a video-viewing type of a plurality of video-viewing types;
for each device of the plurality of devices:
determine a plurality of time intervals of a time range during which the device outputted a video asset; and
use the data structure to determine, based on a video-viewing type and a video-viewing mode associated with each of the plurality of time intervals determined for the device, a subset plurality of time intervals associated with a first video-viewing type and a first video-viewing mode;
determine, based on data records, of the data structure, associated with the subset plurality of time intervals, a video-viewing-activity metric indicating a quantity of devices that outputted, during one or more intervals of a plurality of intervals of the video asset, the video asset using the first video-viewing type and the first video-viewing mode; and
output an indication of the determined video-viewing-activity metric; and
a viewing device comprising:
one or more second processors; and
second memory storing second instructions that, when executed by the one or more second processors, cause the viewing device to send at least a portion of the video-viewing-activity data.

17. The system of claim 16, wherein the first instructions, when executed by the one or more first processors, cause the computing device to:
use the data structure to determine a video-viewing type by determining whether the video asset was outputted from a linear source, from a digital video recorder (DVR) source, or from a video on demand (VOD) source.

18. The system of claim 16, wherein the first instructions, when executed by the one or more first processors, cause the computing device to:
determine, based on the data records and for each time interval of the plurality of time intervals, one of a playback mode, a fast-forward mode, or a rewind mode.

19. The system of claim 16, wherein the first instructions, when executed by the one or more first processors, cause the computing device to use the data structure to determine a video-viewing mode by determining, for each time interval of the plurality of time intervals determined for the device, one of a playback mode, a fast-forward mode, or a rewind mode.

20. The system of claim 16, wherein the video asset comprises an advertisement.
